(19) United States
(12) Patent Application Publication
(10) Pub. No.: US 2024/0371264 A1
(43) Pub. Date: Nov. 7, 2024

(54) TRAFFIC CONTROL AT AN INTERSECTION

(71) Applicant: ZETA SPECIALIST LIGHTING LIMITED, Oxford (GB)

(72) Inventors: Gokhan BUDAN, Oxford (GB); Philip SHADBOLT, Oxford (GB)

(21) Appl. No.: 18/555,830

(22) PCT Filed: Apr. 14, 2022
(86) PCT No.: PCT/GB2022/050947

§ 371 Date: Oct. 17, 2023

(30) Foreign Application Priority Data
Apr. 21, 2021 (GB) 2105672.6

(51) Int. Cl. G08G 1/056; G06N 3/04; G06N 3/092; G08G 1/16; H04W 4/40

(52) U.S. Cl. CPC G08G 1/056; G06N 3/04; G06N 3/092; G08G 1/164; H04W 4/40

(57) ABSTRACT

Apparatus for traffic control at an intersection is described. The apparatus has a neural network architecture to determine priorities for a set of connected vehicles present at the intersection and a trajectory conflict engine to receive the priorities for the set of connected vehicles present at the intersection and to determine timing data for occupation of crossing points of the intersection that avoid collisions between the set of connected vehicles. The neural network architecture maps an observation tensor for lanes of the intersection to a priority tensor for the lanes of the intersection. The observation tensor contains kinematics data for vehicles in the lanes of the intersection. The apparatus uses the timing data to instruct movement of the set of connected vehicles across the intersection.

### TECHNICAL FIELD

The present invention relates to apparatus, systems, and methods for the control of a set of vehicles at an intersection using a neural network architecture. Certain described examples relate to the use of an intersection control agent, a device that communicates with vehicles approaching an intersection to control the crossing of the intersection without incident. Certain described examples also relate to a method of training a neural network architecture for use in traffic control. The present invention may be considered to generally relate to the field of control systems engineering, and in particular to the field of traffic control engineering, which considers the electronic control of complex stochastic systems. Certain examples may be deemed to relate to signalling, and in particular traffic control systems for road vehicles.

### BACKGROUND

The humble motor vehicle is entering a time of transition comparable to the introduction of the internal combustion engine. On the one hand, environment concerns are requiring vehicles to use carbon neutral fuel sources, such as electric batteries; on the other hand, advances in so-called “artificial intelligence”, machine learning and communications connectivity are enabling autonomous capabilities. Yet motor vehicles remain one of the largest threats to life in the modern world. For example, traffic accidents are the leading cause of death globally for children and young adults; over a million lives are lost per year to traffic fatalities and many millions more suffer life-changing non-fatal injuries. Accident data indicates that intersections, portions of road traffic systems where vehicles interact, are especially problematic. They accounted for between 34-38% of fatalities in the United Kingdom (UK) and around 20-21% of fatalities across the European Union (EU) throughout the years 2005-2014 (as determined by the Directorate General for Transport of the European Commission).

A great majority of accidents happen due to human error. The trend for better automated vehicle control offers hope. So-called Connected and Autonomous Vehicles (CAVs) are seen as one way in which fatalities and injuries may be significantly reduced. CAVs are also believed to potentially reduce fuel consumption and traffic congestion. For example, the increased sensory precision and the smoother acceleration and speed control capabilities of these vehicles enables more efficient use of existing road networks.

However, there are considerable challenges associated with integration of CAVs into traffic management on public roads. For example, there will be a long transitional period in which traditional human-driven vehicles and CAVs will co-exist in traffic. There will also be different levels of autonomy. This means that advanced CAV-enabled traffic management systems will also need to support mixed fleet operations. This is no easy task. How to integrate CAVs into the transportation ecosystem is an unsolved problem and up until now the development of CAV-enabled infrastructure has been seen as extremely risky. For example, the requirements for control infrastructure for CAV-specific roads have not been examined in depth and may differ from current road specifications. This leads to a causality dilemma, infrastructure providers are unable to adopt new technologies until proven, but there are few technologies that can be tested on public roads.

US 2019/0236948A1 (Fujitsu Limited) describes an intersection management system (IMS) that may receive one or more traversing requests from one or more Connected Autonomous Vehicles (CAVs). The IMS may determine a solution space for each of the one or more traversing requests in a space-time resource model of the intersection and find a CAV trajectory allocation in the space-time resource model for each of the one or more traversing requests. The IMS may send an approved reservation to each CAV corresponding to each of the one or more CAV trajectory allocations that have been found. Each of the one or more CAVs may, when an approved reservation corresponding to the CAV may have been received from the IMS, move through the intersection zone as specified in the approved reservation. However, the solution of US 2019/0236948A1 has a problem in that the IMS is not scalable to a wide variety of intersections, such as intersection types that differ from those considered in the patent publication including the wide range of urban intersection configurations. Also, following analysis the present inventors question the possible efficiency of the described solution in busy urban traffic.

US2018/0275678A1 (Arizona State University) describes an apparatus for intersection management of autonomous or semi-autonomous vehicles. The apparatus may include an input interface to receive an intersection crossing request from one or more autonomous or semi-autonomous vehicles, the request including vehicle data. An output interface is coupled to a transmitter. An analyser is coupled to the input interface and to the output interface to process the request, based, at least in part, on the vehicle data, to generate a command including a crossing velocity and a time to assume the crossing velocity. The analyser causes the transmitter, via the output interface, to transmit the command to the requesting vehicle. The solution in US2018/0275678A1 mainly focuses on a wireless communications system for intersection management and the dataset needed to provide such management.

KR20130007754A (Korean Electronics and Telecommunications Research Institute) describes a vehicle control device in an autonomous driving intersection and a method of assigning an entry priority to a vehicle without a traffic light, thereby performing autonomous driving management. In particular, a monitoring unit monitors a vehicle located in an intersection within a service radius. A collision zone information management unit classifies the service radius into a plurality of zones. The collision zone information management unit manages collision zone information corresponding to a plurality of zones. A collision prediction unit predicts a collision possibility in a zone in which a vehicle is located. The collision prediction unit calculates a collision estimated time. A priority determination unit selects a vehicle priority and sets up an entry predicted time. A communication unit delivers vehicle control information to the vehicle. The solution described in KR20130007754A only applies to CAVs and does not consider mixed-fleet operations. Hence, it would be difficult to implement in real-world scenarios.

CN105654756A (Shenzhen Casun Intelligent Robot Co Ltd) discloses an autonomous traffic control method for Automated Guided Vehicles (AGVs). The autonomous traffic control method comprises the steps as follows: a first AGV, AGV-A, obtains an intersection identifier, and judges whether the AGV-A is in a control region or not according to the intersection identifier. The AGV-A then transmits first traffic information to other AGVs through a short-distance communication module when judging that the AGV-A is in the control region. The AGV-A receives second traffic information transmitted by a second AGV, AGV-B; the AGV-A obtains whether a line A and a line B have an intersection point or not when judging whether the AGV-B and the AGV-A are in the same control region according to the intersection identifier; and if the line A and the line B have the intersection point and the receiving time of the second traffic information is earlier than the transmitting time of the first traffic information, the AGV-A implements traffic control and stores the identifier of the AGV-B into an M region of a control pool. The autonomous traffic control method has the advantages that collision is avoided; and the running efficiency of the AGVs is improved. This method uses heuristic methods to manage the AGVs and thus has limited flexibility for real-world traffic flows.

CN107608351A (South China University of Technology) discloses an autonomous traffic control device and method of controlling an AGV. According to the invention, before entering a traffic control region, the AGV first stops, and enters application instructions for many times that are sent in a private time window of the AGV; if no AGV acquires the traffic control right in the traffic control region, the AGV enters and acquires the traffic control right; if other AGVs have acquired the traffic control right, the application will be rejected and applications can be continuously made in the next private time window; and after the AGVs which have acquired the traffic control right leave, preferential vehicles waiting for entering will be removed from the queue, and the removed vehicles are started and acquire the traffic control right. Meanwhile, based on the time window conversation mechanism, a communication occupation problem is solved; based on the traffic control right handing over mechanism, an abnormal control problem is solved. By use of the method, communication success rate can be greatly improved; active entering of the AGVs is avoided; the AGVs can be automatically recovered from the abnormity; safety and operation efficiency are improved; and orderliness of the system is improved. The solution in CN107608351A suffers from the problem that it only works for particular traffic networks, such as those in which the level of congestion is low. The methods in CN107608351A are unlikely to be able to handle majority of the cases where traffic demand is high.

US 2018/0096594 A1 describes systems and methods for adaptive and/or autonomous traffic control. The method may include receiving data regarding travel of vehicles associated with an intersection, using neural network technology to recognize types and/or states of traffic, and using the neural network technology to process/determine/memorize optimal traffic flow decisions as a function of experience information. Exemplary implementations may also include using the neural network technology to achieve efficient traffic flow via recognition of the optimal traffic flow decisions. US 2018/0096594 A1 uses a neural network architecture to determine signalling data for a set of traffic light signals at an intersection. It may thus be seen as an advanced form of Traffic Light Control (TLC). As such, US 2018/0096594 A1 still suffers from TLC problems known in the art.

Other traffic control systems and methods are described in US20190311617 A1, CN 108281026 A, KR20190042873A, CN106218640A, CN108932840A and US 2013/0304279 A1.

In general, there is a desire for improved traffic control methods and systems that improve safety at intersections and/or allow for mixed fleet control. In particular, there is a desire for traffic control methods and systems that are able to successfully operate in a wide range of real-world scenarios.

### SUMMARY OF THE INVENTION

Aspects of the present invention are set out in the appended independent claims. Variations of these aspects are set out in the appended dependent claims. Examples that are not claimed are also set out in the description below.

### BRIEF DESCRIPTION OF THE DRAWINGS

Examples of the invention will now be described, by way of example only, with reference to the accompanying drawings, in which:

FIG. 1 is a schematic illustration showing an example apparatus for traffic control at an intersection.

FIG. 2 is a chart illustrating how different traffic control processes are implemented with respect to distance from the intersection and time.

FIG. 3 is a schematic illustration showing control of a set of lead connected vehicles at the intersection of FIG. 1.

FIG. 4 is a schematic illustration showing an example of connected vehicle sequencing at an intersection.

FIG. 5A is a schematic illustration showing an example neural network architecture being used over a plurality of timesteps to output priorities for a set of connected vehicles at an intersection.

FIG. 5B is a schematic illustration showing recurrent neural network components of FIG. 5A in more detail.

FIG. 6 is a schematic illustration showing different example crossing points on an example intersection.

FIG. 7 is a schematic illustration showing how timing data for a set of connected vehicles may be determined.

FIG. 8 is a schematic illustration showing an example system for training a neural network architecture for intersection traffic control.

FIG. 9 is a schematic illustration showing example components to implement an intersection control apparatus.

FIG. 10 is a series of charts showing how examples of the described systems perform relative to comparative traffic control systems.

FIG. 11 is a flow chart showing an example method of controlling traffic flow at an intersection.

FIG. 12 is a flow chart showing an example method of training a neural network architecture for a traffic control system.

### DETAILED DESCRIPTION

### Introduction

Certain examples described herein provide apparatus, systems, and method for electronic control of traffic at an intersection. Certain examples allow for autonomous intersection control, i.e. control of traffic for a mixed fleet of vehicles that may comprise autonomous and semi-autonomous vehicles, where the control is typically applied without human intervention. Certain examples described herein present a form of non-signalised traffic control, i.e. allow control of traffic on an intersection without explicit signalling such as traffic lights. The present examples provide solutions that use artificial intelligence, and in particular examples neural network architectures configured according to a reinforcement learning framework, to control traffic at an intersection. The present examples may be used as increased levels of autonomous or semi-autonomous vehicles (including so-called “self-driving cars”) enter public roads and mix with existing vehicles.

Certain examples described herein may be used to implement and/or retrofit a Vehicle-To-Infrastructure (V2I) enabled traffic signal system that supports operation of a mixed fleet of vehicles. Certain examples may help to lower accident and implementation risk of automated traffic control at an intersection by taking a holistic perspective of traffic control. Certain examples develop the emerging role of connectivity and vehicle autonomy in the context of traffic control. Certain examples additionally improve capacity and/or safety benefits of Connected and Automated Vehicles (CAVs) using bi-directional vehicular communications. Certain examples also allow for data from network operators to be used to implement safety measures. For example, traffic data collected and controlled by the intersection control agent as described in examples herein may be used to control traffic outside of any one particular intersection, e.g. vehicles may be informed in advance of arrival at an intersection of traffic issues and/or intelligent diversions may be implemented if accidents are detected. In this sense, the intersection control agents described herein may form part of a networked traffic control system for a whole city or town.

In certain examples described below, a disruptive traffic control method is proposed that may be implemented without traffic lights, i.e. as a form of unsignalised traffic control. Certain examples integrate the increasing wireless connectivity of vehicles and ever-growing CAV features to make better use of the road transport infrastructure. Certain examples use a neural network architecture to implement a Reinforcement Learning (RL) based decision making mechanism to manage intersection crossing of vehicles in a proactive way to reduce journey times, congestion and improve safety. Unlike a typical Traffic Light Control (TLC) method where each direction of traffic on the road is given right-of-way as a batch of vehicles in turn with traffic lights, in certain proposed examples, vehicles are assigned with priorities individually by an artificial-intelligence-based control agent, and a dedicated intersection crossing time window is allocated for each vehicle. Certain examples use a model-free approach, in which learning of the traffic environment dynamics happens in a trial-and-error way, e.g. via the training of the neural network architecture, which provides many benefits over comparative TLC systems that, in general, are based on complex mathematical traffic models in order to optimise signal timings for a given intersection. Certain examples described herein allow real-time traffic control decisions to be made in a proactive way under constantly evolving traffic conditions whilst ensuring a higher degree of safety in the absence of any physical traffic light system.

### Certain Term Definitions

The term “traffic” is used to refer to the movement or passage of vehicles along routes of transportation. A “vehicle” may be considered any device for the conveyance of one or more of people and objects. Vehicles may include autonomous as well as manually controlled vehicles. Vehicles may be self-propelled. Although reference is primarily made to road vehicles, methods may also be applied to other forms of vehicles that interact along transport routes, such as ships and planes. The term “connected vehicle” is used to refer to a vehicle with communications hardware for the communication of data with external entities. Preferably the communications hardware comprises a wireless interface, such as a wireless networking interface such as WIFI or a telecommunications interface such as one conforming to any telecommunications standard, including, but not limited to, the Global System for Mobile Communications (GSM), 3G, 4G, Long Term Evolution (LTE®), and 5G, as well as future standards. The term “autonomous” is used to refer to aspects of vehicle control that are not provided explicitly by a human driver. As discussed herein there may be different levels of autonomy, from full human control (zero autonomy) to no human control (full autonomy) and levels in between. Reference to autonomous vehicles made herein refer to vehicle with any level of autonomous capability. Certain vehicles may not include a human controller or passenger. In certain cases, connected vehicles may comprise a combination of connected yet manually controlled vehicles and connected vehicles with autonomous capabilities (also referred to herein as CAVs).

The term “intersection” is used as per manuals in the art of traffic infrastructure to refer broadly to any transport structure where traffic meets. For example, an intersection may include, amongst others, Y and T junctions, roundabouts, and crossroads. An intersection typically has two or more approaching links and one or more exit links. A link may have one or more lanes for traffic. An intersection may have one or more critical areas where vehicles have the potential to meet, e.g. where approaching links or lanes meet at a common area. A critical area may be divided into discrete areas referred to herein as “crossing points”. The term “control area” is used to define an area where connected vehicles may communicate with at least one control device associated with the intersection. It may be predefined and/or based on a communications range. The terms “movements” and “manoeuvres” are used to describe actions of vehicles within space and time at the intersection, e.g. in particular with respect to the critical area.

In examples described herein, an intersection control agent is implemented using at least one neural network architecture. The term “neural network architecture” refers to a set of one or more artificial neural networks that are configured to perform a particular data processing task. For example, a “neural network architecture” may comprise a particular arrangement of one or more neural network layers of one or more neural network types. Neural network types include convolutional neural networks, recurrent neural networks and feed-forward neural networks. Convolutional neural networks involve the application of one or more convolution operations. Recurrent neural networks involve an internal state that is updated during a sequence of inputs. Recurrent neural networks are thus seen as including a form of recurrent or feedback connection whereby a state of the recurrent neural network at time (e.g. t) is updated using a state of the recurrent neural network at a previous time (e.g. t−1). Feed-forward neural networks involve transformation operations with no feedback, e.g. operations are applied in a one-way sequence from input to output. Feed-forward neural networks are sometimes referred to as plain “neural networks”, “fully-connected” neural networks, or “dense”, “linear”, or “deep” neural networks (the latter when they comprise multiple neural network layers in series).

A “neural network layer”, as typically defined within machine learning programming tools and libraries, may be considered an operation that maps input data to output data. A “neural network layer” may apply one or more weights to map input data to output data. One or more bias terms may also be applied. The weights and biases of a neural network layer may be applied using one or more multidimensional arrays or matrices. In general, a neural network layer has a plurality of parameters whose value influence how input data is mapped to output data by the layer. These parameters may be trained in a supervised manner by optimizing an objective function. This typically involves minimizing a loss function. A recurrent neural network layer may apply a series of operations to update a recurrent state and transform input data. The update of the recurrent state and the transformation of the input data may involve transformations of one or more of a previous recurrent state and the input data. A recurrent neural network layer may be trained by unrolling a modelled recurrent unit, as may be applied within machine learning programming tools and libraries. Although a recurrent neural network such as a Long Short-Term Memory (LSTM) or Gated Recurrent Unit (GRU) may be seen to comprise several (sub) layers to apply different gating operations, most machine learning programming tools and libraries refer to the application of the recurrent neural network as a whole as a “neural network layer” and this convention will be followed here. Lastly, a feed-forward neural network layer may apply one or more of a set of weights and biases to input data to generate output data. This operation may be represented as a matrix operation (e.g. where a bias term may be included by appending a value of 1 onto input data). Alternatively, a bias may be applied through a separate addition operation. The term “tensor” is used, as per machine learning libraries, to refer to an array that may have multiple dimensions, e.g. a tensor may comprise a vector, a matrix or a higher dimensionality data structure. In preferred example, described tensors may comprise vectors with a predefined number of elements.

To model complex non-linear functions, a neural network layer as described above may be followed by a non-linear activation function. Common activation functions include the sigmoid function, the tanh function, and Rectified Linear Units (RELUs). Many other activation functions exist and may be applied. An activation function may be selected based on testing and preference. Activation functions may be omitted in certain circumstances, and/or form part of the internal structure of a neural network layer.

The example neural network architectures described herein are configured to be trained using an approach called backpropagation. During backpropagation, the neural network layers that make up each neural network architecture are initialized (e.g. with randomized weights) and then used to make a prediction using a set of input data from a training set (e.g. a so-called “forward” pass). The prediction is used to evaluate a loss function. If gradient descent methods are used, the loss function is used to determine a gradient of the loss function with respect to the parameters of the neural network architecture, where the gradient is then used to back propagate an update to the parameter values of the neural network architecture. Typically, the update is propagated according to the derivative of the weights of the neural network layers. For example, a gradient of the loss function with respect to the weights of the neural network layers may be determined and used to determine an update to the weights that minimizes the loss function. In this case, optimization techniques such as gradient descent, stochastic gradient descent, Adam etc. may be used to adjust the weights. The chain rule and auto-differentiation functions may be applied to efficiently compute the gradient of the loss function, working back through the neural network layers in turn.

Certain examples described herein use a neural network architecture to implement an intersection control agent that acts as an agent within the area of machine learning known as “reinforcement learning”. Within reinforcement learning agents are configured to take “actions” based on a “state” representing an environment, where the agent is configured based on a “reward”.

In certain cases, a notion of an expected cumulative reward or “Q value”. The terms “action”, “state”, “reward”, and “Q value” are to be interpreted as used in the art of reinforcement learning, with specific adaptations for the present examples as described in detail below.

The term “engine” is used herein to refer to either hardware structure that has a specific function (e.g., in the form of mapping input data to output data) or a combination of general hardware and specific software (e.g., specific computer program code that is executed on one or more general purpose processors). An “engine” as described herein may be implemented as a specific packaged chipset, for example, an Application Specific Integrated Circuit (ASIC) or a programmed Field Programmable Gate Array (FPGA), and/or as a software object, class, class instance, script, code portion or the like, as executed in use by a processor.

The term “interface” is used herein to refer to any physical and/or logical interface that allows for one or more of data input and data output. An interface may be implemented by retrieving data from one or more memory locations, as implemented by a processor executing a set of instructions. An interface may also comprise physical or wireless couplings over which data is received. An interface may comprise an application programming interface and/or method call or return. For example, in a software implementation an interface may comprise passing data and/or memory references to a function initiated via a method call; in a hardware implementation, an interface may comprise a wired interconnect between different chips, chipsets or portions of chips. In the drawings, an interface may be indicated by a boundary of a processing block that has an inward and/or outward arrow representing a data transfer.

### An Example Intersection

A number of examples will now be described herein. An example intersection with sixteen lanes will be used as a reference, but this form of intersection is not to be seen as limiting. As discussed above, the present examples may be applied to many different forms of intersection while maintaining the described functionality.

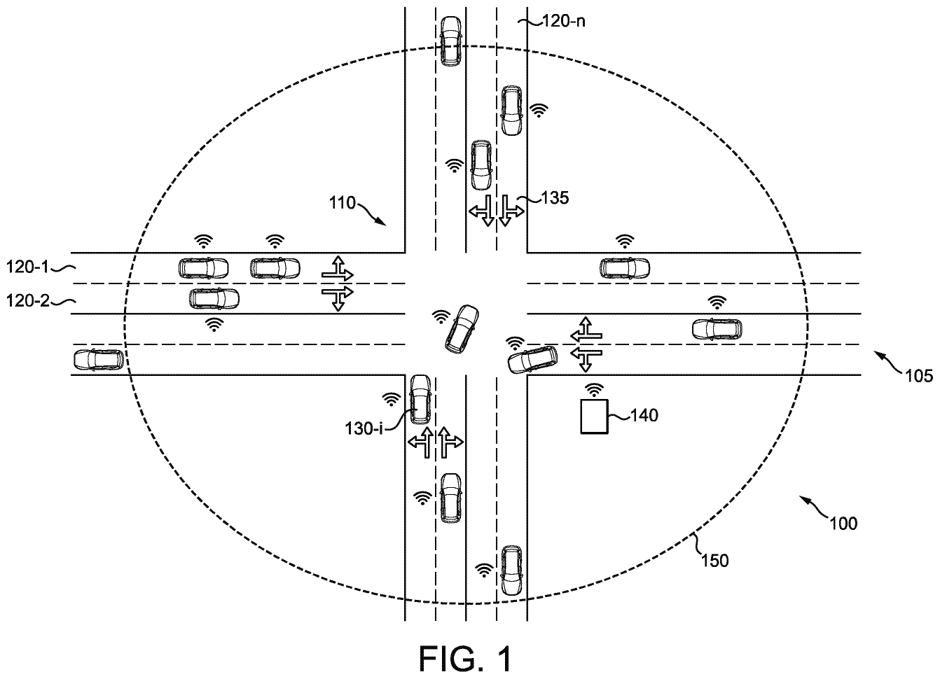

FIG. 1 shows an example intersection 100 with multiple approaching and exit links 105 that meet at an intersection critical area 110. Whether a link is an approaching or exit link depends on a direction of traffic, which may be configured as per road traffic laws in a country of implementation. In a minimum case, there may be two approaching links and one exit link. A link may comprise one or more lanes. In the present example, there are four pairs of approaching and exit links 105 arranged orthogonally, but this is just one of many different configurations, and links and/or lanes need not be arranged orthogonally. Each link comprises multiple lanes 120. In the example of FIG. 1, each link has two lanes, such that there are a set of sixteen lanes in total. The lanes may be split into two groups: a set of incoming lanes available on the approaching links and a set of outgoing lanes available on the exit links. The set of incoming lanes may be referenced using an index n, where there are N lanes in total, i.e. l₁ . . . lₙ, n∈N. The set of incoming lanes meet at the intersection critical area 110, and the set of outgoing lanes emerge from the intersection critical area 110.

FIG. 1 also shows a set of connected vehicles 130-i that are using the intersection 100. In the present example, the vehicles 130-i are connected via wireless communications systems installed in the vehicles. However, the connected vehicles 130-i may be connected in any manner, e.g. as described in the section above. The connected vehicles 130-i may comprise a mixed fleet of fully autonomous vehicles, semi-autonomous vehicles, and manually controlled vehicles. At the intersection critical area 110, the connected vehicles 130-i undertake a set of movements to move from an incoming lane to an outgoing lane. The connected vehicles 130-i may select an outgoing lane automatically based on an indicated destination (e.g., as indicated by a user using a global positioning or routing system) or a user of the connected vehicle may manually control the vehicle or otherwise indicate to take a desired outgoing lane. Typically, traffic at the intersection is subject to the constraints of the traffic laws of the country or state of the intersection. For example, in FIG. 1, permitted left turn, right turn and through movements are shown with road markings 135, wherein different movements are available from different lanes 120.

As can be seen in FIG. 1, there is a problem of controlling the set of connected vehicles 130 at the intersection critical area 110 and the intersection critical area 110 has the potential for lateral vehicle collision. In comparative approaches, a solution to this problem is to use traffic lights with traffic light control systems based on complex hand-coded models of traffic flow. For example, a traffic survey team will typically install cameras and traffic sensors to measure traffic flow at the intersection 100 over a series of weeks or months, and then a traffic control team will attempt to develop a set of timing rules for traffic lights that keep traffic flowing. It should be noted that often there is the constraint that only one set of rules may be applied, or that only crude time-based control is possible (e.g., based on hours of use), so the traffic control team must develop hand-crafted rules that provide acceptable traffic flows on average. In practice, this means that most, if not all, traffic light control systems experience problems when traffic flow changes unexpectedly (e.g., for holidays vs workdays, big events, traffic accidents etc.) and that even slow changing patterns of use (e.g., a new housing or industrial estate) are not accommodated and require the traffic survey team to repeat the initial monitoring so that a new set of rules may be developed.

FIG. 1 also shows a new apparatus for traffic control at the intersection 100, in the form of an intersection control agent 140. The intersection control agent 140 has a control range 150 based on a wireless communications range. Within the control range 150, the intersection control agent 140 communicates with the connected vehicles 130 to control traffic flow across the intersection critical area 110. The intersection control agent 140 may form part of a Road Side Unit (RSU) with Vehicle-to-Infrastructure (V2I) communication capabilities to collect vehicular data from approaching connected vehicles 130. As such, the intersection control agent 140 may comprise a connected vehicle interface to receive communications from one or more connected vehicles 130 as said vehicles approach the intersection 100 and enter the control range 150. The communications may comprise kinematics data from each connected vehicle, including data such as vehicle identification number, position, velocity, and desired trajectory through the intersection 110.

In the present example, the intersection control agent 140 controls traffic flow across the intersection critical area 110 by modelling the intersection critical area 110 as a set of crossing or conflict points. These crossing points may comprise a discrete division of the intersection critical area 110. In use the intersection control agent 140 is configured to determine timing data for occupation of the crossing points of the intersection that avoid collisions between the set of connected vehicles 130. This timing data may comprise crossing time windows for each approaching vehicle (e.g., each lead vehicle in each lane, if there is one). This timing data may be transmitted from the intersection control agent 140 to the connected vehicles 130, e.g. via the connected vehicle interface of the intersection control agent 140. The intersection control agent 140 uses a trajectory conflict engine to determine the timing data. The trajectory conflict engine computes the timing data such that only a single connected vehicle is present in each crossing point at any moment in time. For example, the trajectory conflict engine may split time into a number of discrete timing windows and select at most one connected vehicle to occupy each crossing point for each timing window. In effect, the intersection control agent 140 applies spatio-temporal control in which time windows are allocated for each connected vehicle 130 at crossing points to enable safe crossing. The details of the time windows may then be disseminated by the intersection control agent 140 to the set of connected vehicles 130 within the control range 150. The intersection control agent 140 thus coordinates the set of connected vehicles 130 without additional signalling such as traffic lights.

In examples described herein, traffic control at an intersection such as 100 is improved by using a neural network architecture to determine priorities for a set of connected vehicles present at the intersection, such as connected vehicles 130. These priorities are then used by the trajectory conflict engine to determine the timing data for occupation of crossing points of the intersection. In one case, the intersection control agent 140 comprises a neural network architecture that implements a reinforcement learning policy. In this case, a set of priorities for connected vehicles represent an “action” determined from an “action space” for the intersection. The set of priorities are determined by mapping an observation tensor for lanes of the intersection to a priority tensor for the lanes of the intersection. The priority tensor may represent a crossing order of vehicles at the intersection in which selecting a vehicle as an action is an available element in the action space. The observation tensor is determined using kinematics data for vehicles in the lanes of the intersection, e.g. as received over the wireless communications system described with respect to FIG. 1. The kinematics data for vehicles may comprise kinematics data for individual vehicles (such as lead connected vehicles in each lane) and/or aggregate kinematics data (i.e., traffic flow data) for individual lanes of the intersection. In the case that the neural network architecture implements a reinforcement learning policy, the observation tensor may represent a “state” of the intersection and a reward function may be defined based on a state transition. In one case, a reward function is based on vehicle delay times at the intersection. In this case, vehicle delay times include both individual and aggregate delay times, e.g. delay times for individual vehicles and groups of vehicles such as all vehicles present at the intersection and/or groups of vehicles on each lane. In one case, a reward function may comprise a term that is derived from the averaged delay times of all vehicles present at the intersection and/or per lane. The reward function may be computed based on states that result following a given action, e.g. an action changes a current state to a next state. States in the present case may involve physical locations (e.g., in terms of relative distances) and proprieties of the vehicles at the intersection. Where a reward function is implemented, the parameter values of the neural network architecture are trained based on an optimisation of the reward function. For example, the neural network architecture may be trained to maximise the reward function, which may be equivalent to minimising aggregate vehicle delay times at the intersection. From real-world test implementations, the present examples have been found to provide improved traffic flow, e.g. with lower average vehicle delay times at the intersection.

### Example Process Diagram

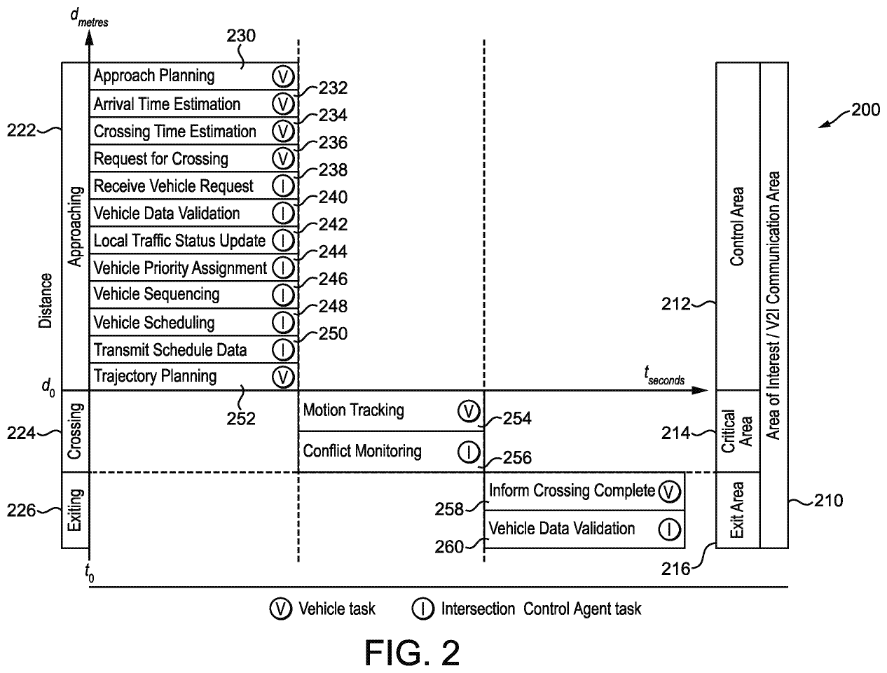

FIG. 2 is a process diagram 200 showing a set of example processes that may be performed by the connected vehicles 130 and the intersection control agent 140 during control of traffic flow. The process diagram 200 sets out example processes that may be performed as a connected vehicle 130 approaches and navigates the intersection critical area 110. The process diagram 200 has a distance axis and a time axis. The distance axis represents a distance of a connected vehicle 130 to the intersection critical area 110. The time axis represents the passage of time with respect to the connected vehicle 130. It should be noted that FIG. 2 is not meant to show a detailed timing sequence and the processes shown are illustrative rather than limiting; however, FIG. 2 provides an example of different acts that may be performed at both the connected vehicle 130 and the intersection control agent 140. The exact timing and processes may vary between implementations and models of connected vehicle 130 and intersection control agent 140. It should also be noted that the processes shown in FIG. 2 may be being repeated in parallel for a plurality of connected vehicles present at the intersection 100.

On the right-hand side of the process diagram 200, the different spatial areas of the intersection 100 are shown, aligned with the distance axis. The process diagram 200 takes place within an area of interest 210, which may correspond to the control range 150 shown in FIG. 1. The area of interest 210 may be defined based on a V2I communication area. In one case, an intersection control agent 140 may be responsible for broadcasting regular messages to announce the presence of an unsignalised traffic control service provided by the intersection control agent 140. Connected vehicles that are approaching the intersection 110, may monitor such messages so that they can participate in the traffic control service. Participation may be enacted by exchanging data upon the wireless communication channels. In one case, the area of interest 210 for the unsignalised traffic control system is defined as the area within which connected vehicles are able to establish direct wireless communication with a roadside unit implementing the intersection control agent 140. In other cases, the area of interest 210 may be a defined area, e.g. based on a radius of X metres from a centre of the intersection.

In FIG. 2, the area of interest 210 is then further divided into three different areas where different activities occur: a control area 212, which represents an area covered by the connected vehicle 130 as it approaches the intersection critical area 110; the critical area 214, which represents the intersection critical area 110; and an exit area 216, which represents an area covered by the connected vehicle 130 as it moves away from the intersection critical area 110. The control area 212 may correspond to an approach lane 120 used by the connected vehicle 130 and the exit area 216 may correspond to an exit lane 120 taken by the connected vehicle 130. As shown on the left-hand side of FIG. 2, three different sets of processes occur in each area: a set of approaching processes 222 are performed in the control area 212; a set of crossing processes 224 are performed in the critical area 214; and a set of exiting processes 226 are performed in the exit area 216. These may be seen as different modes for the connected vehicles, and connected vehicles may transition between these modes over time. As shown in FIG. 2, these three different sets of processes roughly occur at three different time periods, thus the process diagram 200 is approximately split into nine sections, where the approaching processes 222 are performed in a first section, the crossing processes 224 are performed in a central fifth section (counting in a raster order), and the exiting processes 226 are performed in a last ninth section. As stated above, the processes may not all be performed exactly in parallel as shown in each section, however the schematic illustration helps conceptualise the operation of the connected vehicle 130 and the intersection control agent 140.

In FIG. 2, sixteen different processes are performed. These are split between vehicle processes that are indicated by a “V” and intersection control agent processes that are indicated by an “I”. The vehicle processes may be executed by at least one processor on board a connected vehicle. The intersection control agent processes may be executed by at least one process on board apparatus implementing the intersection control agent, e.g. an embedded computing system forming part of the RSU. FIG. 2 shows how processes are organised in a spatio-temporal way in which the x-axis is time and y-axis is the distance from the intersection 110. On FIG. 2, the intersection entry point is marked as do.

Turning to the approaching processes 222, these comprise: approach planning 230, arrival time estimation 232, crossing time estimation 234, a request for crossing 236, receipt of a vehicle request 238, vehicle data validation 240, a local traffic status update 242, vehicle priority assignment 244, vehicle sequencing 246, vehicle scheduling 248, schedule data transmission 250 and trajectory planning 252. Approach planning 230, arrival time estimation 232, crossing time estimation 234, the request for crossing 236, and trajectory planning 252 are performed by the connected vehicle 130. Receipt of a vehicle request 238, vehicle data validation 240, a local traffic status update 242, vehicle priority assignment 244, vehicle sequencing 246, vehicle scheduling 248, and schedule data transmission 250 are performed by the intersection control agent 140. In the present examples, a key process at the intersection control agent 140 is the vehicle priority assignment 244, which is where the intersection control agent 140 applies a neural network architecture to determine priorities for a set of connected vehicles that may then be used for vehicle sequencing 246 and vehicle scheduling 248.

The control of the traffic is mainly performed during approach, i.e. as part of approaching processes 222. The crossing processes 224 primarily consist of monitoring processes to ensure that the crossing of the critical area 214 proceeds as planned. In FIG. 2, the crossing processes 224 comprise motion tracking 254, which is performed by the connected vehicle 130, and conflict monitoring 256, which is performed by the intersection control agent 256. Conflict monitoring 256 may be performed across the set of connected vehicles that are currently using the intersection 100. The exiting process 226 are performed on completion of a successful crossing of the critical area 214 and act to conclude the traffic control for a particular connected vehicle. The exiting processes 226 consist of a crossing completion process 258 performed at the connected vehicle to inform the intersection control agent 140 that the crossing for the connected vehicle is complete, and a data validation process 260, which is performed at the intersection control agent 140. Motion tracking 254 may comprise longitudinal vehicle motion tracking. This may involve speed and acceleration control to meet the spatio-temporal planning parameters during intersection crossing. Conflict monitoring 256 may involve the intersection control agent 140 monitoring whether any vehicle is behind or ahead of their scheduled crossing so that other vehicles may be informed accordingly to prevent incidents. The crossing completion process 258 may comprise simple signalling to inform the intersection control agent 140 that a given connected vehicle has left the intersection. The data validation process 260 may involve the intersection control agent 140 validating that a given connected vehicle has left the intersection (e.g., following signalling received from the given connected vehicle at operation 258) and removing the given connected vehicle from the spatio-temporal planning operations and any tracking lists.

In general, during the approaching processes 222, the intersection control agent 140 receives at least distance and timing data from the connected vehicles within the control area 212. This distance and timing data is used to generate an observation tensor (e.g., a vector) for use as input to the neural network architecture. In one case, the distance and timing data is useable to derive an estimated arrival time of the connected vehicle to an entry point of the intersection and a distance of the connected vehicle to an entry point of the intersection. For example, when a connected vehicle 130 first enters the area of interest 210, this triggers execution of approach planning 230 within the vehicle control system of the connected vehicle 130. The approach planning 230 may comprise mapping its own geo-location with respect to map data featuring the intersection. The map data may be loaded from on-board sources, received from a mapping service and/or received from the intersection control agent 140. Approach planning 230 may also comprise determining a correct lane based on the desired trajectory of the connected vehicle through the intersection and the turning manoeuvre restrictions within the critical area 214, and, if necessary, positioning the connected vehicle within that lane. This may be performed, with respect to the vehicle, manually, in an assisted manner or automatically. Once a connected vehicle is positioned in the correct lane, it performs arrival time estimation 232. Arrival time estimation 232 may comprise the computation of an Estimated Time of Arrival (ETA) to the intersection entry point do. In one case, the ETA may be computed using a free flow traffic assumption by the equation:

$${t}_{ETA} = \frac{{d}_{int}}{{v}_{tar}} + {t}_{init}$$

The variable vₜₐᵣ is the target speed of the connected vehicle and dᵢₙₜ is the distance of the connected vehicle to the intersection entry point (i.e., do) once the target speed is reached. The target speed may depend on the driving behaviour of the connected vehicle and/or the speed limit in the local road network. The variable tᵢₙᵢₜ is the initial acceleration or deceleration time, e.g. the time it takes for the subject vehicle to reach the target speed starting from its current speed v_{curr}. The variable tᵢₙᵢₜ may be computed as below:

$${t}_{init} = \frac{{v}_{tar} - {v}_{curr}}{{a}_{d}}$$

where a_{d} is the desired acceleration or deceleration value. Finally, the vehicle displacement dᵢₙᵢₜ during tᵢₙᵢₜ period may be computed using the equation:

$${d}_{init} = \frac{{v}_{tar}^{2} - {v}_{curr}^{2}}{2 {a}_{d}}$$

from which, the dᵢₙₜ can simply be found as:

$${d}_{int} = {d}_{curr} - {d}_{init}$$

where d_{curr} is the current distance of the vehicle from the intersection entry point (i.e., d₀). In certain preferred examples, desired vehicle driving behaviour such as target speed, acceleration etc. is decided by the connected vehicle itself and is respected by the intersection control agent 140. This marks a difference from certain comparative traffic control systems that impose speed profiles for approaching vehicles, e.g. as determined by a comparative control agent. This offers more freedom for a greater variety of vehicle control implementations. It also allows compatibility with different types of autonomous vehicles and/or different degrees of autonomy. For example, the information may be computed for a manually controlled vehicle as well as for autonomous and semi-autonomous vehicles.

Returning to FIG. 2, the next operation performed by the connected vehicle 130 is crossing time estimation 234. This may comprise determining, at the connected vehicle, a current lane of the intersection for the connected vehicle and a desired exit lane of the intersection for the connected vehicle and using distance and timing data to derive an estimate of a crossing time for the connected vehicle. The crossing time is an estimate of the time to move across a desired set of one or more crossing points within the critical area 214, i.e. an estimate of the time to more from the current lane, across the intersection critical area 110, to the desired exit lane. Crossing time estimation 234 may comprise determining the time that it takes for the subject connected vehicle to cross the critical area 214 depending on the target manoeuvre (i.e., left turn, straight passage etc.) and the target speed while making manoeuvre.

In FIG. 2 processes 230 to 234 are performed at the connected vehicle. In other examples, they may be performed external to the connected vehicles, e.g. using external sensors located at the intersection. However, it has been found that traffic control is facilitated when processes 230 to 234 are performed at the connected vehicle, for example, as it allows a variety of connected vehicle implemented with a mixed fleet and allows greater vehicle autonomy and independence, which makes implementation easier in cases where there are a large variety of heterogeneous vehicles.

In FIG. 2, once the subject connected vehicle has executed processes 230 to 234 to determine distance and timing data, which may be broadly referred to as kinematics data for the vehicle, it transmits this data to the intersection control agent 140 as part of an intersection crossing request 236. The intersection control agent 140 receives and processes requests from the set of vehicles in the control area 212 at process 238. To assign priorities to connected vehicles at the intersection 100, the intersection control agent 140 generates an observation tensor that acts as a representation of the traffic state. In FIG. 2, the generation of the observation tensor is performed as a two-stage process that comprises validating the data received from the connected vehicles via the vehicle data validation 240 and ensuring that the representation of the traffic state is up-to-date with regard to the collective set of connected vehicles, e.g. at least the vehicles in the control area 212, via the local traffic status update 242. Thus, prior to the vehicle priority assignment 244, connected vehicles send their information to the intersection control agent 140, information is collected from all relevant vehicles and an input for the neural network architecture is computed. The neural network architecture is then able to determine the priority of at least the lead vehicles in each in-use approaching lane of the intersection.

### Traffic State Representation

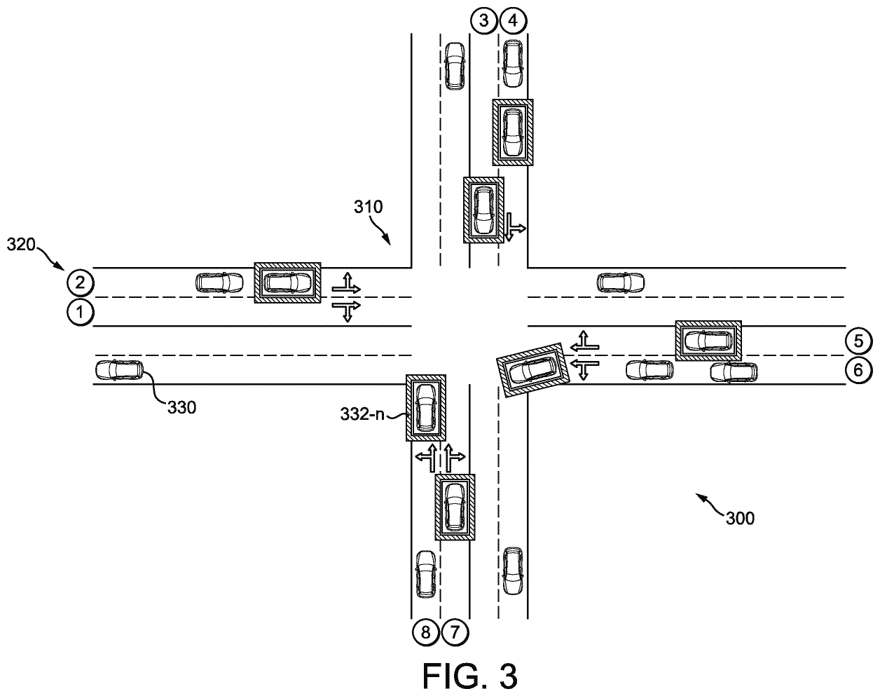

As described above, the neural network architecture of the intersection control agent may receive a traffic state representation as input. In particular, the traffic state representation may be embodied as an observation tensor, i.e. an array structure as described earlier. FIG. 3 illustrates how the traffic state representation may be determined.

FIG. 3 shows an intersection 300 similar to intersection 100 of FIG. 1. FIG. 3 shows an example four-way intersection with two lanes on each approaching link. The intersection 300 has an intersection critical area 310 equivalent to the intersection critical area 110. To build the traffic state representation, the approaching lanes 320 are numbered sequentially. Connected vehicles 330 use the intersection. The lanes may be numbered according to a predefined direction conventional, in FIG. 3 they are numbered sequentially in a clockwise direction starting from the west approaching link, but any suitably numbering scheme may be used. In the present example, the traffic state representation is determined with respect to lead connected vehicles 332 in each in-use approaching lane. In FIG. 3, the lead vehicles are shown within a hashed frame. The control method may be implemented with respect to a set of discrete time steps representing a sampling interval for the intersection. In certain cases, the lead vehicle is defined as the vehicle with the shortest distance to the intersection critical area 310 on a particular lane.

In the present example, an observation tensor is implemented as an observation vector sₜ where t is a time step for the control method. Time steps may take integer values corresponding to discrete time steps. In this case, the observation vector may be defined as:

sₜ={s₁,s₂, . . . ,s_{N}}
where N is the total number of approaching lanes for an intersection (N=8 for FIG. 3) and sₜ is an aggregation of individual observation vectors on each approaching lane. For example, in one case, the overall observation tensor for the intersection may comprise a concatenation along a selected vector direction of all the individual lane observation vectors, i.e. to generate a long flattened input vector. In this example, sₙ denotes an observation of the traffic state on a particular approaching lane of an intersection where n∈ [symbol] . For example, n may comprise an integer (from 1 to 8 in FIG. 3) representing the approaching lane number.

In examples described herein, an observation vector for a given lane may comprise data useable to derive one or more of crossing parameters for a lead connected vehicle in the given lane and aggregate kinematics for connected vehicles in the given lane. Crossing parameters may comprise kinematics data such as distance and time data that represent the position and movement of the lead connected vehicle in each lane with respect to the intersection entry point for that lane (i.e., where the approaching lane meets the intersection critical area 310).

As a specific example, the observation vector for each lane, sₙ, may comprises data useable to derive one or more of: an autonomy level of a lead connected vehicle for the given lane; a distance of the lead connected vehicle to the intersection with respect to the given lane; an estimated arrival time of the lead connected vehicle to the intersection with respect to the given lane; an identifier for the given lane; an identifier for a desired exit lane of the intersection for the lead connected vehicle; an aggregate vehicle speed for the given lane; an aggregate vehicle delay for the given lane; and a measure of the aggregate vehicle delay for the given lane as compared to an aggregate vehicle delay for the set of in-use lanes of the intersection. For example, the observation vector for each lane, sₙ, may be defined as:

sₙ={alᵥₑₕ,dᵢₙₜ,tₐᵣᵣ,lₐᵣᵣ,lₑₓᵢₜ,vₗₐₙₑ,t_{delay},r_{delay}}

where:
alᵥₑₕ represents an autonomy level of the lead vehicle. This may comprise an integer level, e.g. where each autonomy level is represented with a unique identification number. In one case, the SAE J3016 standard set of autonomy levels may be used, which represent a scale of 0 to 5 as published by SAE International, a Pennsylvania, US, not-for-profit corporation.
dᵢₙₜ represents a distance of the lead vehicle to the intersection critical area 330 on lane n. This may be represented in metres.
tₐᵣᵣ represents the arrival time of the lead vehicle to the intersection critical area 330 on lane n. This may be represented in seconds
lₐᵣᵣ represents an arrival lane identifier for the lead vehicle. This may equal n, the lane number, or may comprise a different numeric identifier.
lₑₓᵢₜ represents an exit lane identifier for the lead vehicle. Similar to the approaching lanes, the exit lanes may also be sequentially numbered (e.g., from 1 to 8 in FIG. 3) and so the desired exit lane for the lead vehicle may be this exit lane number, or a different numeric identifier.
vₗₐₙₑ represents an aggregate vehicle speed for the lane. This may comprise an average vehicle speed in km/h on lane n (or any other suitable statistical metric). In one case, this may comprise a weighted aggregate measure, such as the weighted average of speed of all vehicles on lane n. In a preferred case, the weight may comprise the respective travel time of the vehicles. By using this preferred weighting, vehicles that have just entered the network have less influence on the aggregate value than vehicles that have been travelling on the approaching lane for a longer time.
t_{delay} represents an aggregate vehicle delay for the lane. This may comprise an average vehicle delay in seconds on lane n. An average vehicle delay may be calculated by dividing the total vehicle delay on lane n by the number of vehicles on lane n. The total vehicle delay may be computed as the aggregation of the delay values per vehicle, where the delay values per vehicle may be obtained by dividing the actual distance travelled in the current timestep by the difference of the desired vehicle speed and the actual vehicle speed.
r_{delay} represents a ratio of the average vehicle delay on lane n to the total vehicle delay on all approaching lanes.

The state representation that is introduced above essentially consists of lead vehicle kinematics data (alᵥₑₕ, dᵢₙₜ, tₐᵣᵣ, lₐᵣᵣ, lₑₓᵢₜ) and average traffic flow parameters (vₗₐₙₑ, t_{delay}, r_{delay}) for each lane on the approaching links. This kind of representation reduces the observation vector size significantly as opposed to representing the parameters of all vehicles in the observation vector. This then allows for a more tractable neural network mapping, easier training and more stable parameter values. The generation of the average traffic flow parameters may be performed as part of the local traffic status update 242 in FIG. 2.

In a preferred implementation, data forming the observation tensor is normalised prior to being provided as input to the neural network architecture. In one case, the observation vector variables described above may be normalized with respect to a pre-determined maximum value such that all values are in the range of [0, 1]. For example, if the average vehicle speed is 15 km/h and the speed limit is 30 km/h on that lane, then vₗₐₙₑ will have the value of 0.5.

In certain cases, the scale and distribution of the observation vector values may differ from each other. In this case, the neural network architecture may comprise a linear input layer to apply a linear transformation to accommodate these differences. This avoids the need for larger weight values in the neural network as the spread of a vector value gets larger and can help prevent unstable behaviour, poor performance during model training and high generalisation error during model evaluation. An example input layer is shown later in this description.

### An Example Action Space

In the examples above, data used to derive the input for the neural network architecture of the intersection control agent was described. In the section below, example data output from the neural network architecture will be described in more detail. As discussed above, in preferred examples, the neural network architecture implements a reinforcement learning policy. Within a reinforcement learning framework, a policy is defined that maps states to actions. In the present case, the observation tensors described in the examples above form the input states for the policy. To implement a smart traffic control system, the output actions of the neural network architecture are defined with respect to priorities of the connected vehicles at the intersection, in particular, in certain examples, the priorities of the lead connected vehicles for each approaching lane of the intersection. An action may then be seen as the selection of a vehicle for scheduling, which may be performed based on the priorities. In one case, scheduling may take place over time, such that a set of actions may be represented as an ordered list of vehicles or lanes representing the order of connected vehicles at the intersection for crossing scheduling.

In reinforcement learning implementations, the set of actions in an environment that an agent can take to reach its goal is called the action space. There are two types of actions, discrete and continuous. A chess game is an example environment that may be defined with a discrete action space, as there are a finite set of available moves for an agent to take. On the other hand, a throttle and steering control environment for a connected vehicle may have a defined continuous action space, as the actions may be represented with real number values within certain limits or ranges. In a preferred example of the present traffic control system, an action space A is defined as a continuous action space that contains the vehicle priorities for all approaching lanes. For example, for a timestep t, which corresponds to the state timesteps discussed above, an action space Aₜ at time step t for the traffic control system may be defined:

Aₜ={p₁,p₂, . . . ,p_{N}}
where denotes pₙ identifies a vehicle priority on in (lane n) for N total number of approaching lanes. The lanes may be defined as for the observation vectors above, e.g. for the example of FIG. 3, N is a fixed-value for a given intersection and equals 8. In the examples described here, the neural network architecture is trained to map an observation tensor to a priority tensor, where the priority tensor represents the crossing order of the vehicles at the intersection where each action belongs to the At action space set. The priority tensor may thus represent or be used to derive the output of the vehicle priority assignment 244 in FIG. 2. The priority tensor represents a crossing order of vehicles at the intersection in which selecting a vehicle as an action is an available element in the action space.

In more detail, in the intersection of the Figures, N=8 and Aₜ={p₁, p₂, . . . p₈}represents the action space. In other words, there are 8 available actions as the given example intersection has 8 approach lanes, where each action may be seen as the selection of the lead vehicle on that particular lane. For example, consider a simple scenario where there are an equal number of vehicles, say 2, approaching the intersection on every approach lane. This means that in one control cycle, the intersection control agent generates a list of priorities for 16 cars. In this case, a priority list might resemble the following:

Priority list=[1,2,2,1,3,5,6,3,4,4,6,5,7,7,8,8]
where each number in the ordered list referred to the selection of the lead vehicle on a lane of the corresponding number (e.g., 1 refers to the selection of the lead vehicle on lane 1). In one case, the priority list may store the selected priority value for each selected lead vehicle or lane instead of the lane number, e.g.:

Priority list=[p₁,p₂,p₂,p₁,p₃,p₅,p₆,p₃,p₄,p₄,p₆,p₅,p₇,p₇,p₈,p₈].
where p₁, for example, refers to the selection of the lead vehicle on lane 1. This example shows that an intersection control agent is only allowed to select actions from the defined action space (e.g., 8 actions in total for the example intersection); however, the priority list size depends on the number of vehicles at the intersection (and of course will change over time as different numbers of vehicles approach the intersection on each approaching lane). The control cycle for the intersection control agent may be a predefined time period (e.g., each t refers to a sampling at a predefined sampling frequency). If a control cycle is, for example, 5 seconds, then every control cycle the generated priority list will be extended with the new vehicles approaching in the next 5 seconds. The new vehicles will never be placed in front of the vehicles which already have assigned priorities, i.e. any newly arriving vehicles will be selected as above and the lanes of the lead vehicles will be added onto the end of the pre-existing priority list. Vehicles may be removed from the generated priority list as they are scheduled for crossing and/or successfully complete a crossing of the intersection.

In operation, the intersection control agent 140 may be configured to select an action at each timestep based on a value for the action space Aₜ. This may take place as part of vehicle sequencing 246 as shown in FIG. 2. In one case, the intersection control agent 140 selects an action aₜ=max (Aₜ) at each timestep t, which is essentially the highest priority lead connected vehicle across the approaching lanes of the intersection. The selected vehicle may then be placed into a priority assignment list for intersection crossing as is described in more detail below.

In certain cases, to facilitate computation, certain actions may be masked out for selection. For example, certain elements or variables may not be available. This may be applied when there is no vehicle approaching the intersection on a particular lane and/or when there is no vehicle left to process on a particular lane for priority assignment. In one case, action selection may receive a masked set of actions, e.g. a vector with only certain elements available for use. In one case, A(s)⊆A may be used to denote a masked action space for state s, i.e. a set of actions that are available for selection by the intersection control agent 140. For example, in practice, an observation vector for lanes that do not have any vehicles may be filled with a fixed or predetermined set of data. This may be equivalent to a virtual vehicle modelled as being furthest away from the intersection with a very large or infinite arrival time to the intersection crossing area. In this way, the intersection control agent may be configured not to give priority to the virtual vehicle if there are real vehicles much closer to the intersection crossing area.

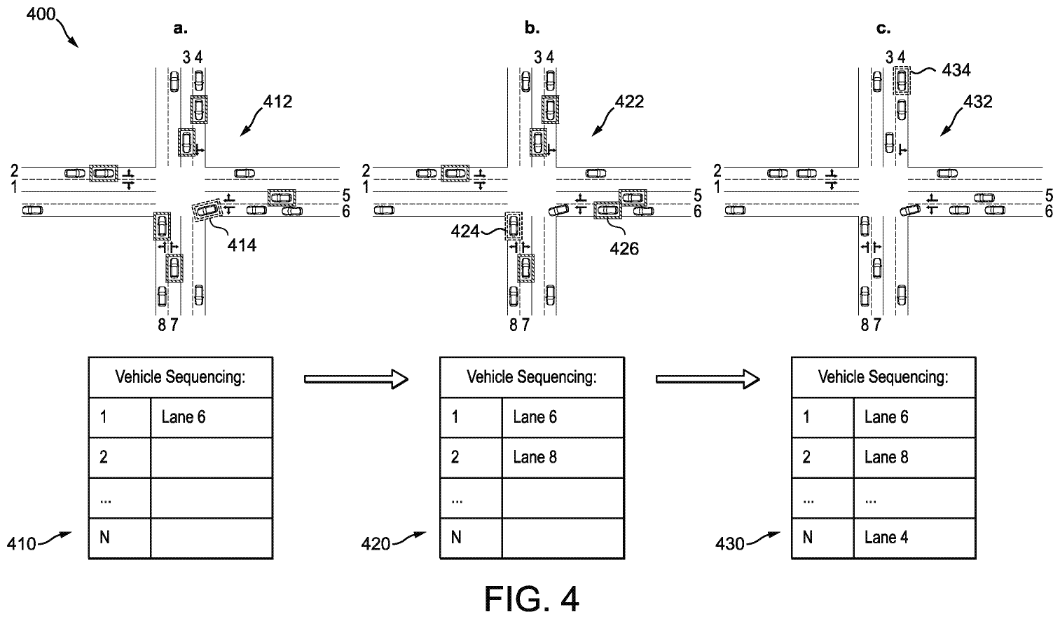

FIG. 4 shows an example 400 of action selection based on the intersection 300 and the set of lead connected vehicles 332 shown in FIG. 3. For a given timestep, the intersection control agent 140 determines a vehicle priority list. The vehicle priority list is based on an output of the neural network architecture, which generates a set of priorities for each lane representing the action space at a given time step, subject to any masking constraints (e.g., based on empty lanes). The vehicle priority list 410, 420, 430 is shown developing over time, e.g. as discussed above.

In the example of FIG. 4, as the intersection has eight approaching lanes, Aₜ={p₁,p₂,p₃,p₄,p₅,p₆,p₇,p₈}. For the example, the intersection control agent 140 starts with an empty vehicle priority list. At the timestep t, the neural network architecture outputs estimated values for Aₜ. In the state shown in FIGS. 3 and 4, there are no connected vehicles on lane 1 so a set of masked actions for the shown state may by represented as A(s) {pᵢ}ᵢ₌₂⁸; in effect, the intersection control action is prevented from selecting lane 1 in the action selection process because of the masking. All other approaching lanes have connected vehicles as shown with the hashed boxes. More explicitly, at point a) in FIG. 4, Aₜ (s)={p₂,p₃,p₄,p₅,p₆,p₇,p₈}. Out of this set of priorities, the intersection control agent selects the largest priority as the first entry in the list, i.e. aₜ=max(Aₜ(s)). In FIG. 4a, this is p₆, and so the action is the selection of lane 6. This is shown via the dashed box around the lead vehicle in lane 6 of FIG. 4a. In other words, the action is the selection of the lead connected vehicle in lane 6 as the first entry in the priority list for the subsequent crossing determination.

After the selection of the first vehicle in FIG. 4a, FIG. 4b shows the selection of a subsequent vehicle for the next slot in the vehicle priority list. For every iteration, a new set of lead connected vehicles is selected. For example, as the first vehicle in lane 6 was selected in FIG. 4a, the next vehicle in lane 6 shown by 426 forms part of the group of connected vehicles in FIG. 4b. If after a previous iteration, there are no longer any selectable vehicles in a given approaching lane, then that approaching lane may be masked as for lane 1 above. As the set of connected vehicles changes from iteration to iteration, the observation vector changes and a new prediction may be obtained from the neural network architecture, subject to any applied masking. In general, the vehicle sequencing process is repeated until all vehicles are sequenced for intersection crossing. For example, the procedure in FIG. 4 may be performed every control cycle or interval t as described above. FIG. 4 shows the very last vehicle 434 being selected as the last entry in the priority list, where the effective action space is Aₜ(s)={p₄}. In other words, all actions apart from selecting lane l₄ are masked in the last step.

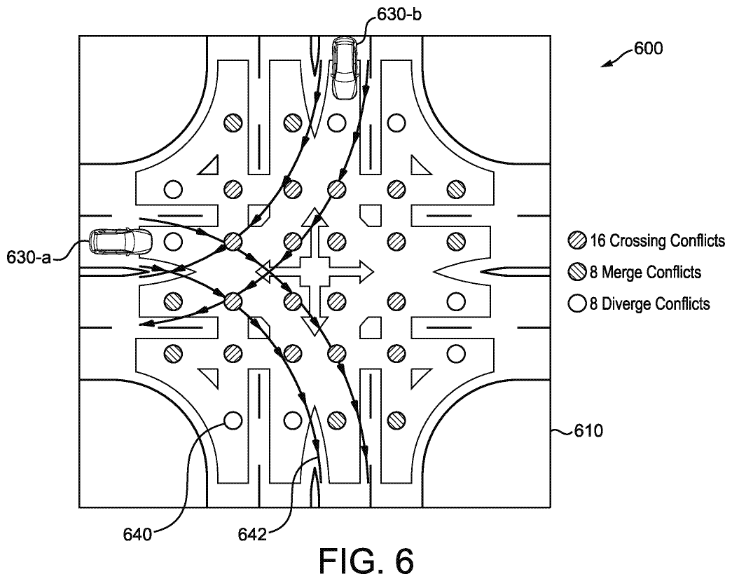

The output of the vehicle sequencing process 246 in FIG. 4 is a sequence of ordered lane selections. This represents a set of priorities for crossing the intersection critical area 310, i.e. the list of lane selections indicates a lead connected vehicle ordering for the crossing of the intersection critical area. This process may be executed every control cycle or interval (i.e. every sample t). Approaching vehicles with no priority yet may be buffered. The sequence of ordered lane sequences forms an input for the vehicle scheduling process 248, which is described later with respect to FIG. 7. The role of the neural network architecture in the unsignalised traffic control system is thus to determine the priority of the vehicles for intersection crossing. Buffering may be performed depending on the length of the control cycle or interval. For example, consider a case where four vehicles are approaching the intersection on different lanes and their distance to the intersection varies. These four vehicles will enter the control range 150 at different times. If these times all fall within a control interval the four vehicles are buffered to be prioritised in the next iteration of the control cycle (e.g., the next t). The control interval may be selected as a hyperparameter based on implementations and/or routine experimentation. By buffering vehicles for each control cycle, the intersection control agent is kept updated as to the state of the intersection by observing all buffered vehicles data in batches.

### Neural Network Architecture

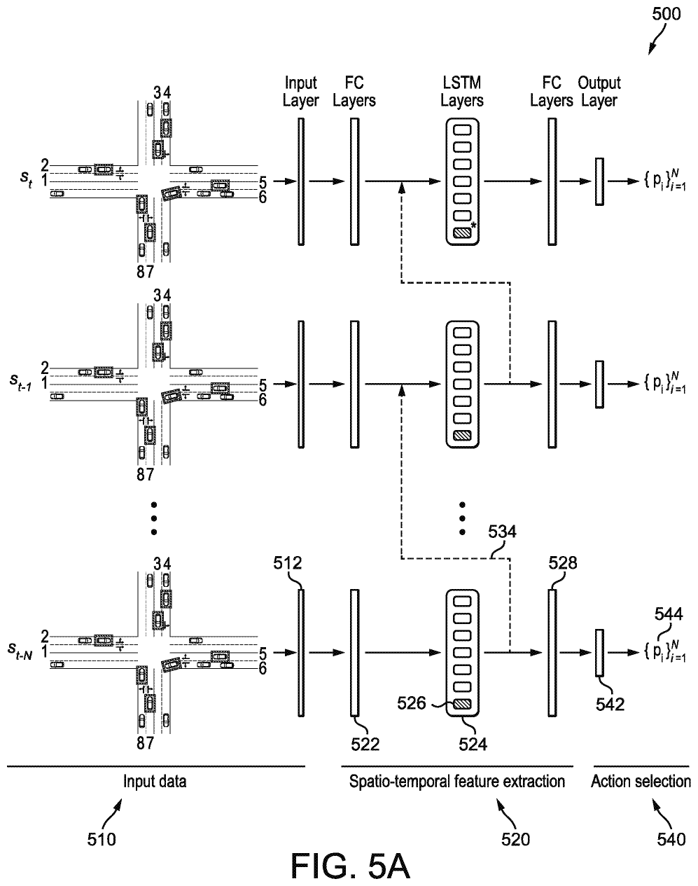

FIGS. 5A and 5B show example components of one neural network architecture that may be used by an intersection control agent to determine a set of priorities for connected vehicles at an intersection. In the example 500 of FIGS. 5A and 5B, the neural network architecture comprises three portions: an input portion 510, a spatio-temporal feature extraction portion 520 and an action selection portion 540. These different portions may be considered different layers of a multi-layer or “deep” neural network. The input portion 510 is configured to receive an observation tensor, e.g. as determined above based on kinematics data for a set of lead connected vehicles in each in-use lane and/or aggregate kinematics data for vehicles in addition to the lead connected vehicles, and to pre-process this prior to the spatio-temporal feature extraction portion 520. This is shown schematically by the illustrated state of the intersection in FIG. 5A. The observation tensor may comprise a joined or concatenated set of observation vectors for all the lanes of the intersection (e.g., an input vector) and the input portion 510 may include a normalization operation as described above. In FIG. 5A the input portion 510 comprises an input layer 512. This may comprise a linear transformation layer as explained above and may function similar to an embedding layer in other neural network architectures. The output of the input layer 512 is then passed to the spatio-temporal feature extraction portion 520.

In FIG. 5A, the spatio-temporal feature extraction portion 520 comprises one or more hidden fully-connected neural network layers 522 to process data derived from the observation tensor (in this case, a vector output from input layer 512); one or more recurrent neural network layers 524 to process data derived from the one or more hidden fully-connected neural network layers; and one or more output fully-connected neural network layers 528 to process data derived from the one or more recurrent neural network layers and to output data for use in deriving the priority tensor. The spatio-temporal feature extraction portion 520 is trained to extract or encode relevant features from the observation tensor over time, based on correlations within the variables of the observation tensor for any one time step and correlations over observation tensors for different time steps. The spatio-temporal feature extraction portion 520 may be considered as a set of hidden layers that extract features from the input data. As is shown in more detail in FIG. 5B, in the present example, the one or more recurrent neural network layers 524 comprise Long Short Term Memory (LSTM) layers; however, other recurrent neural network layers such as Gated Recurrent Unit (GRU) layers may be used. Additionally, in certain examples the one or more recurrent neural network layers may be replaced with one or more attention-based fully-connected layers, e.g. as found within so-called Transformer neural network architectures, to provide the same learnt spatio-temporal feature extraction function. The feature tensors that are output by the spatio-temporal feature extraction portion 520 are then received by the action selection portion 540, which in this example comprises an output layer 542. The output layer may comprise one or more fully-connected or linear neural network layers to map a higher dimensionality feature vector as output by the spatio-temporal feature extraction portion 520 to an action space vector 544, which may have N elements where N is the number of approaching lanes in the intersection. Example hyperparameters for a test implementation of the neural network architecture are set out in a later paragraph for reference.

FIG. 5A shows the details of the neural network in which sₜ is the observation vector at timestep t. The objective of fully-connected layers in the network is to extract spatial features i.e. the hidden relationship between vehicle positions, speeds, distances etc. On the other hand, the recurrent layers extract the temporal features, i.e. the effect of previous outputs on the current state. In the example, of FIG. 5A there are multiple recurrent neural network layers where certain layers receive output data from a lower layer. In FIG. 5A, seven layers are shown for example, but the number of layers may be selected as a hyperparameter depending on the implementation. The set of layers in effect process data across a time window of multiple time steps (the window having a size proportional to the number of layers). The fact that an output from a previous time step is used in a future time step is shown by dashed line 534. In FIG. 5A, the same neural network architecture is applied across N multiple timesteps. N may equal the number of recurrent neural network layers.

A closer look at the structure of the recurrent (LSTM) cells for each time step 526 is provided in FIG. 5B. At timestep t, the LSTM unit 550 receives a previous cell state vector cₜ₋₁ and a hidden state vector hₜ₋₁ as an input together with the observation vector sₜ. Each LSTM unit 550 comprises a first sigmoid function 552, a first pointwise product block 554, a second sigmoid unit 556, a first tanh function 558, a second pointwise product block 560, an addition block 562, a third sigmoid function 564, a third pointwise product block 566, and a second tanh function 568. The information flow inside the LSTM cell is regulated via three gates, namely input, output and forget gates. These gates are composed of sigmoid functions and pointwise product blocks to control how (i.e., to what extent) the current input data should be remembered or forgotten in the next timestep. Hence, the forget gate is composed of the first sigmoid function 552 and the first pointwise product block 554, the input gate is composed of the second sigmoid function 556 and the second pointwise product block 560 and the output gate is composed of the third sigmoid function 564 and the third pointwise product block 566.

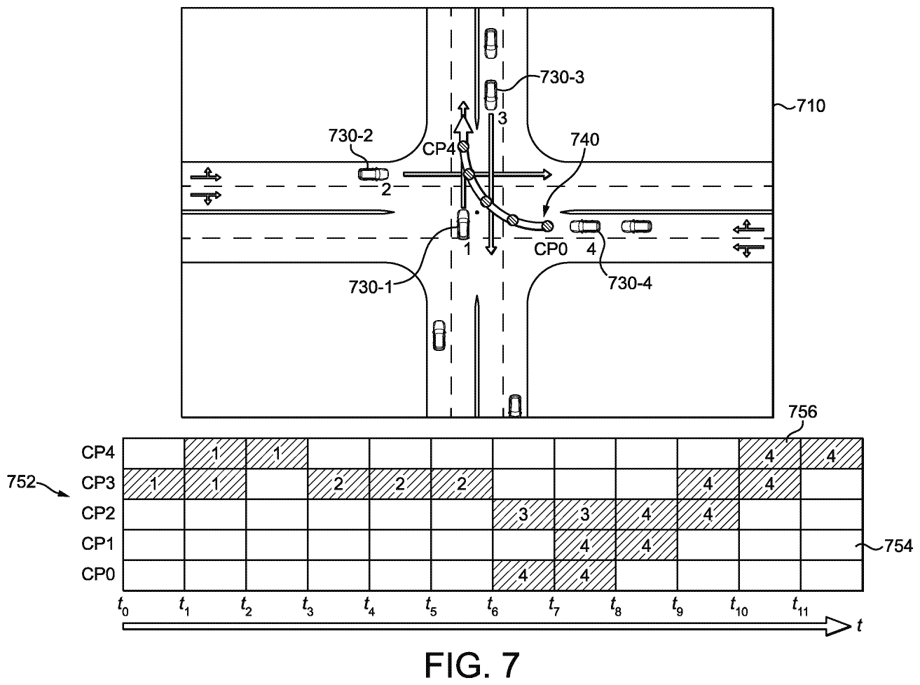

In general, the neural network architecture implements a policy that is parameterized via the neuron weights and biases of the neural network layers, such as those shown in FIGS. 5A and 5B. Determination of the neuron weights and biases is performed via an optimisation process during training. An example training procedure is described in more detail later with respect to FIG. 8.

### Example Trajectory Conflict Resolution Procedure

Returning to the process diagram of FIG. 2, the output of the vehicle priority assignment 244 and vehicle sequencing 246 processes are respectively priorities for a set of connected vehicles, e.g. a set of priorities for lead connected vehicles in each lane, and an ordered list of lanes representing the order of the priorities. Following this, the intersection control agent 140 undertakes a vehicle scheduling process 248. The vehicle scheduling process 248 is performed by the trajectory conflict engine of the intersection control agent 140 to determine timing data for occupation of crossing points of the intersection that avoid collisions between the set of connected vehicles. In particular, crossing time windows may be generated so that each vehicle knows when they are allowed to cross the intersection.

In examples presented herein, the trajectory conflict engine models the intersection critical area 110 as a series of crossing or conflict points. These are discrete divisions of the intersection critical area 110 for the modelling of traffic control. In certain cases, crossing points for an intersection may be defined by transportation institutions, such as in published guidelines and/or manuals that define and/or standardise various aspects of road networks. These institutions may also define standardised intersection geometries that may be used to define the crossing points. For example, the Federal Highway Administration (FHWA) in the USA has publications that define standardised crossing points for intersections. Different countries may use different crossing point geometries based on their own respective standards.

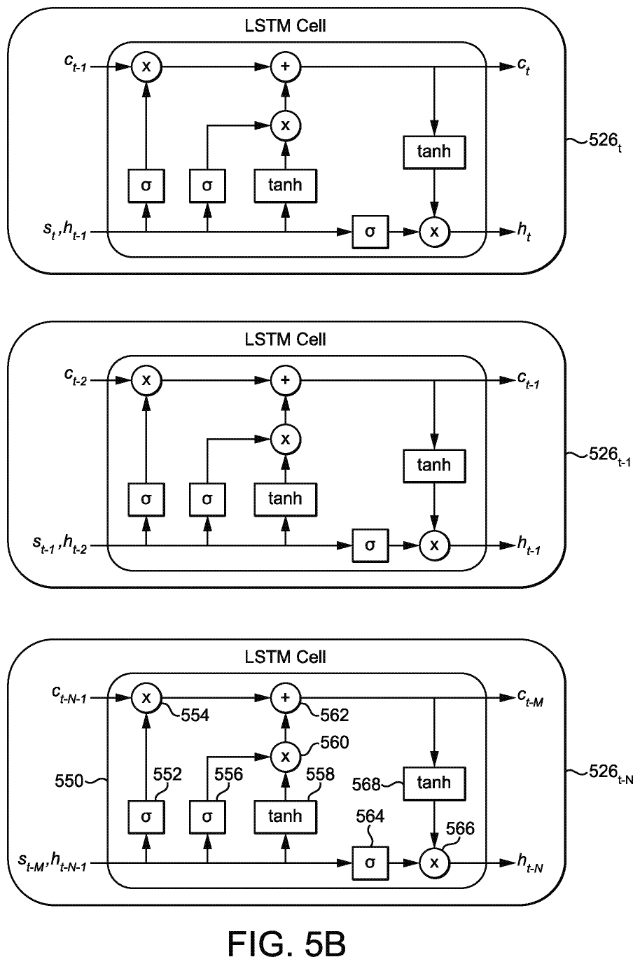

As an example, a set of crossing points for the example four-way intersection described above (assuming left-hand drive) is shown in FIG. 6. The example 600 of FIG. 6 shows a close-up 610 of the intersection critical area (e.g., as previously described) with two connected vehicles 630 shown. In FIG. 6, there are three types of crossing points 640: crossing, merge and diverge, as shown with different hashing schemes inside the intersection critical area. There are 32 crossing points in total where there is a risk of lateral vehicle collision. The objective of the trajectory conflict engine and the vehicle scheduling process 248 is to schedule vehicles crossing with time windows so that only one vehicle occupies each crossing point at any given time.

In FIG. 6, each connected vehicle 630-a and 630-b needs to undertake a different crossing manoeuvre to reach a desired exit lane. These crossing manoeuvres are shown by arrowed lines 642. These manoeuvres may each be modelled as a vehicle trajectory trajᵢ, where i indicates a particular approaching vehicle. In the present case, the vehicle trajectory may be modelled as an ordered list of crossing points, i.e. representing crossing points the vehicle passes during the crossing movement. This may be represented as an ordered set trajᵢ={cp}ⱼ₌₀^{K} where K is the total number of crossing points cpⱼ along the trajectory of vehicle i.

In a preferred example, the trajectory conflict engine obtains trajectory data indicating arrival lane-exit lane pairs for a set of connected vehicles, e.g. the lead vehicles in each selected lane, and generates an ordered list of crossing points, i.e. a trajectory, for each connected vehicle under consideration based on the indicated arrival line and the indicated exit lane. To ensure that no collisions occur, timing data is determined based on the times that a vehicle i occupies a given crossing point cp, where cp forms part of the trajectory of the vehicle (i.e. cp∈trajᵢ). This timing data may comprise (or be based on) tᵢ(p), a time that vehicle i occupies crossing point cp.

The determination of timing data for vehicle scheduling may use a crossing velocity v_{cross} for a vehicle. This may be assumed to be uniform. It may be decided by a connected vehicle and communicated to the intersection control agent 140 via a V2I communication. If a connected vehicle is entering the intersection critical area from an initially stopped condition at the entry point of the intersection, then the vehicle acceleration, across, may be assumed to be uniform until the crossing velocity v_{cross} is reached. Even though across and v_{cross} are assumed to be uniform, a safety buffer of ±Δv_{cross} and ±Δa_{cross} may be added to the calculations as a tolerance to ensure that there is room for error as vehicles cross the intersection and that there is sufficient safe spatio-temporal space between vehicles with conflicting trajectories. Given, a modelled vehicle crossing velocity, vehicle crossing start and duration times may be computed by the trajectory conflict engine based on the particular trajectory trajᵢ of the vehicle through the intersection, e.g. as determined from the approach and exit lanes. In one case, the trajectory conflict engine computes the travel time between crossing points in the trajectory for a given vehicle using the distance between pairs of crossing points and the vehicle crossing velocity v^{cross}. For example, for vehicle i, the travel time tₜᵣₐᵥ_{ᵢ} constraints between two consecutive crossing points cp₁, cp₂∈trajᵢ with a distance of d_{cp}_{ᵢ}(cₚ₁, cₚ₂) considering ±Δv_{cross} safety buffer may be computed using as a range of times based on:

$$\frac{{d}_{{cp}_{i}} ( {cp}_{1} , {cp}_{2} )}{{v}_{cross} - Δ {v}_{cross}} \leq {t}_{{trav}_{i}} \leq \frac{{d}_{{cp}_{i}} ( {cp}_{1} , {cp}_{2} )}{{v}_{cross} + Δ {v}_{cross}}$$

In this case, once tₜᵣₐᵥ_{ᵢ} is calculated between all successive pairs of crossing points in the vehicle trajectory trajᵢ, the crossing times may be used to allocate certain vehicles to certain crossing time windows. For example, this may be performed by applying a suitable crossing time window search within a trajectory conflict resolution table as shown in FIG. 7.

FIG. 7 shows the allocation of crossing time windows for an example intersection crossing scenario. The upper part of FIG. 7 shows an intersection 710 of a similar type to previous examples (for ease of explanation) and a set of four lead connected vehicles 730. The desired manoeuvres for each connected vehicle are shown with arrows. A trajectory 740 for the fourth vehicle 730-4 is shown in more detail with five crossing points: CP0 to CP4. The example assumes that connected vehicles 730-1, 730-2 and 730-3 have already been allocated crossing time windows and connected vehicle 730-4 is the next vehicle to consider. As shown, connected vehicle 730-4 has trajᵢ={p}ⱼ₌₀^{K-5}. The order of the connected vehicles here may be the order that results from the operation of the neural network architecture.

The lower part of FIG. 7 shows a trajectory conflict resolution table 752 that may be used to control the crossing of the connected vehicle 730-4. The trajectory conflict resolution table 752 is a data structure that may be used to model the occupancy of crossing points of the intersection over time. In FIG. 7, only the crossing points relating to the trajectory 740 are shown for clarity (i.e., CP0 to CP4). The crossing points define the rows of the table 752. The columns of the table are then defined in terms of standardised time windows of a predefined width, with time passing as indicated by the arrow. Each cell 754 of the table 752 may be assigned a vehicle identifier, indicating that the identified vehicle may occupy the corresponding crossing point for the corresponding time period. To avoid collisions there may be the constraint that only one vehicle identifier may be assigned to any one cell 754. The cells may be populated based on the travel times tₜᵣₐᵥ_{ᵢ} as set out above, and the order in which vehicle identifiers are assigned to cells 754 may be based on the vehicle priorities from the neural network architecture, e.g. the ordered list generated by the vehicle sequencing 246.

Turning to the table 752, even though, connected vehicle 730-4 is ready to cross at to, it is not allowed to cross as there are trajectory conflicts with connected vehicle 730-1 on CP3-4, with connected vehicle 730-2 on CP3 and with connected vehicle 730-3 on CP2. Therefore, the first suitable crossing window for connected vehicle 730-4 starts from t₆ which is the crossing start time that the vehicle is allowed to enter the intersection critical area for crossing. The connected vehicle 730-4 may thus be allocated cells 756 starting with CP-0 at t₆, with cells being populated based on travel times tₜᵣₐᵥ_{ᵢ} computed for consecutive pairs of the crossing points. The trajectory conflict resolution table 752 is thus useable to determine timing data for the connected vehicles 730 that indicates at least a start time for each manoeuvre across the intersection critical area. This timing data may thus be communicated to the connected vehicles 730, e.g. via process 250 in FIG. 2, so that the connected vehicles can cross the intersection without the use of traffic signals such as traffic lights.

### Training a Neural Network Architecture for Traffic Control

In the examples described above a neural network architecture, such as the particular architecture shown in FIGS. 5A and 5B, is used to assign vehicle priorities for controlling the crossing of an intersection, where the vehicle priorities are used to determine times at which vehicles may move across the intersection without collision. The examples above present the neural network architecture in a so-called inference mode. To determine suitable parameter values to perform the described mapping the neural network architecture undergoes a training procedure. During training, by optimising a defined optimisation function, parameter values may be learnt. In the present case, optimisation may be performed using, amongst others one of: gradient training, conjugate gradient training, the quasi-newton method, the Levenberg-Marquardt method, stochastic gradient descent and adaptive linear momentum.

In the case that the neural network architecture implements a reinforcement learning policy, the objective of minimising a loss function as used for many neural network architectures is translated into an optimisation to obtain the maximum possible cumulative discounted reward.

This may be achieved in an iterative manner during training by searching for an optimum parameter set that fits the parameter values of the neural network architecture to the input data from the environment.

In certain examples, training of the neural network architecture may be configured around an objective of controlling traffic at intersections with minimum vehicle delays. In certain cases, training data may be generated using a traffic simulation environment. In this manner, the neural network architecture may learn by trial-and-error as it interacts with data generated using the traffic simulation environment. An example of a traffic simulation environment that may be used for training is the PTV Vissim simulation tool from PTV Group of Karlsruhe, Germany.

In certain examples, a learning problem for a traffic control task may be formulated in terms of a loss factor minimisation that may be optimised using adaptive linear momentum optimisation, known in the art as the “Adam” optimizer. The Adam optimizer is suitable for training in the present case due to its computational efficiency, suitability for problems with noisy and sparse gradients and small memory space requirements. During training, the Adam optimizer executes a search through the neural network parameter space in order to decrease the loss at every epoch (i.e., one full cycle through the training data) and it is done by adjusting the neural network parameters. In particular, the Adam optimizer may compute an exponential moving average of the gradient and the squared gradient when determining the parameter adjustment rate and direction. At first, the neural network architecture may be initialised with a random parameter set and then may be updated every epoch in the direction that minimizes the loss value until a training stop criterion is reached, e.g. the loss decrement in one epoch reaches a plateau.

In certain examples, training of the neural network architecture comprises obtaining training data comprising state transitions for an intersection, such as the intersections of the previous examples. Each state transition in the state transitions may comprise data representing two successive states of the intersection, such as before and after states, with respect to a particular action. The action is as described above, e.g. the selection of a lead vehicle from a certain lane. In this case, the neural network architecture may be trained to predict a set of priorities based on data representing a state of the intersection, and the objective function in this case may comprise a function of an expected cumulative future reward computed from the state transition. In this example, the determined parameter values for the neural network architecture are useable to predict the set of priorities based on an observed state of the intersection. The set of priorities may be used by a traffic control system comprising the neural network architecture to control occupation of crossing points of the intersection that avoid collisions between connected vehicles present at the intersection.

### Reward Functions

Training a neural network architecture based on a reinforcement learning framework is challenging as the reward mechanism that is used during training has great impact on what a neural network architecture learns. Reward mechanisms need to be structured in a way to encourage or discourage an agent implemented by the neural network architecture, such as the intersection control agent described herein, to take a selected action based on the objective of that agent. In this section, example reward mechanisms are discussed, which are based on observed states of traffic flow for an intersection and that, in turn, provide trained neural network architectures that output connected vehicle priorities that allow for improved and autonomous traffic control.

In preferred examples, a reward is defined a scalar value that represents how good or bad an action is, where the action is taken by an agent on a particular environment state. In the present examples, as described above, the action is the selection of a particular lead connected vehicle in a particular lane, where this selection then influences the order in which trajectory conflict planning is performed, and thus, in turn, the start times that particular connected vehicles cross the intersection. In general, a reward at a time t depends on a selected action, and current and next states of the environment, i.e. traffic states. This dependency can be shown as:

rₜ=R(sₜ,aₜ,sₜ₊₁)
where, at timestep t, rₜ is the reward, aₜ is the action taken, sₜ is the current state and sₜ₊₁ is the next state. As described above, in the present examples, the state sₜ is represent by an observation tensor and the action is a selection from the aforementioned action space. The action influences the next state by changing the traffic flow (e.g., changing the lead vehicle in a particular lane, the vehicle positions etc.). It should be noted that some aspects of the next state may not be directly related to the action. However, a reinforcement learning framework allows a neural network architecture to map states to actions that generally, over time, have a high reward despite variability in the environment.

In a traffic control system, an intersection control agent is in operation continuously. As, in this case, a cumulative reward over an infinite horizon is intractable, a discount factor may be applied to a defined cumulative reward to make it tractable. In the present case, a discounted cumulative reward or a discounted return over an infinite horizon may be defined as:

$$R ( τ ) = {\sum }_{t = 0}^{∞} {γ}^{t} {r}_{t}$$

where γ∈(0,1) is the discount factor and t indicates a discrete timestep as used above.

In implementations of the present examples, many different objectives may be used to define the reward for the traffic control application, including those based on one or more of: journey time, junction queue waiting time, junction throughput, preventing stop-and-go movements, accident avoidance and fuel consumption. In preferred implementations, an objective may be defined based on reducing traffic congestion. This may be parameterised based on a reduction of the vehicle delay times during intersection approach and crossing. In one particular test example, the reward for an intersection control agent as described herein at timestep t was defined as a weighted sum of three factors:

$${r}_{1} = \frac{\frac{{T}_{max}}{2} - {t}_{n \_ delay \_ max}}{{T}_{max}} \\ {r}_{2} = \frac{\frac{{T}_{max}}{2} - {t}_{n \_ masked \_ delay \_ max}}{{T}_{max}} \\ {r}_{3} = \{ \begin{matrix}0 , & if {traj}_{{a}_{t} - 1} ⋂ {traj}_{{a}_{t}} = ∅ \\ - \frac{1}{{k}_{n}} , & otherwise\end{matrix}$$

For example, a final reward value may be obtained as a weighted sum of the above reward terms:

$${r}_{t} = {w}_{1} * {r}_{1} + {w}_{2} * {r}_{2} + {w}_{3} * {r}_{3}$$

where rₜ is clipped within [−1, 1] range. In this example, the first reward term, r₁, gives more reward as the average vehicle delay times get smaller on all lanes where t_{n_delay_max} represents the maximum of average vehicle delays on all lanes and Tₘₐₓ is a fixed configuration value to normalise the reward term. The first reward term, r₁, effectively ensures that all lanes have equal importance in reducing overall congestion at the intersection. The second reward term, r₂, gives more reward when the most congested lane is prioritised for vehicle sequencing. Here, t_{n_masked_delay_max} denotes the maximum of the average vehicle delays excluding the masked lanes. In other words, if the intersection control agent assigns vehicle priorities starting from the most congested lane to the least, the r₂ term will increase. The third reward term, r₃, is a negative reward or punishment term to discourage frequent lane switching in the priority assignment. The third reward term r₃ decays exponentially when more vehicles are selected in a row from the same approaching lane, meaning less punishment for the intersection control agent. For the third reward term, r₃, an exponential decay term is used instead of a linear decay as it resulted in less congestion and vehicle delays during the initial experiments in the simulation tool.

It should be noted that these reward terms are shown for example only and were decided based on experimentation, e.g. using a traffic simulation tool with various different weight factors and reward terms. The values of the weights wᵢ, and the particular reward functions used, may be varied between implementations based on experimentation, and alternative reward functions may be used.

### Reinforcement Learning Policy

For improved understanding of the training configuration shown in FIG. 8, a short background on the use of a policy within reinforcement learning will now be provided.

In reinforcement learning, a policy may be defined as a strategy that an agent adopts to achieve its goals. A policy brings together the state representation, action space, reward mechanism and the neural network under a Markov Decision Process (MDP) framework. The policy determines the way an agent behaves at a given time in the environment by having a probability distribution over the action space for the environment states. A policy w can formally be structured as a tuple of the form (S, A, P, R) where S is the state representation, A is the action space, P is the probability matrix of transition from one state to another, and finally, R is the reward mechanism. A policy in reinforcement learning is parameterized via the neuron weights and biases of the neural network, and this is done via an optimisation process during the training session. In the present particular case, the agent is the intersection control agent, the priorities are used to implement an action determined from an action space for the intersection and the observation tensor represents a state of the intersection, and a reward function is defined based on vehicle delay times at the intersection.

In certain examples described in more detail below, an actor-critic configuration is used to train the neural network architecture. The actor-critic configuration may comprise at least one actor version of the neural network architecture described above and at least one critic neural network architecture, wherein the at least one actor version of the neural network architecture is configured to learn a policy that maps a set of priorities as an action to a state of the intersection, and wherein the at least one critic neural network architecture is configured to map state-action pairs to Q values, which represent an expected reward.

In the context of an actor-critic architecture, the actor version of the neural network architecture updates a policy parameter set, θ, for a policy π_{θ}(a|s) as guided by a critic neural network architecture, where the parameter set 0 comprise the weights and/or biases of the neural network architecture that implements the policy. Effectively, the policy π_{θ}(a|s) is a mapping between states and actions, where the aim of the policy is to predict an action given (“I”) a state. In terms of the neural network architecture described herein, the state is the input to the architecture and the output enables an action to be selected. The expected return of an action-state pair for the policy is represented by a Q-value function, Q^{π}(s,a). When the neural network architecture implements a policy w, starting with a random action in state s, the expected return Q^{π}(s,a) may be computed as:

$${Q}^{π} ( s , a ) = E [ R ( τ ) \vert {s}_{0} = s , {a}_{0} = a ]$$

where R(τ) is the sum of discounted rewards as set out in the previous section. Q^{π}(s,a) can alo be interpreted as the expected cumulative future reward. When an optimal policy (e.g., the best strategy that leads the agent to achieve its goals) is used by an agent, the expected return Q^{π}(s,a) is maximised as optimal action decisions are taken every timestep. The optimal action-state pair value may be provided by:

$${Q}^{*} ( s , a ) = {max}_{π} {Q}^{π} ( s , a )$$

i.e. the policy is selected that maximises the expected reward. This can then be translated into a training method for the neural network architecture to attempt to learn an optimal policy.

It may be also noted that multiple action sequences may lead to an optimal value Q*(s,a). In that case, all of those action decision sequences are considered optimal. If Q*(s,a) is obtained, then in a given state, the optimal action to take is also found by:

$${a}^{*} ( s , a ) = arg {max}_{a} {Q}^{*} ( s , a )$$

i.e. selecting the action that maximises the optimal expected reward.

In certain examples described herein, a traffic control action space was modelled as a continuous action space. In this case, finding a*(s,a) among infinite action choices may be difficult (and even intractable) as it requires computing the Q-values for each possible action every timestep to determine which one is the optimal action. To overcome this issue, a gradient-based learning rule for a policy in(s) may be defined that presumes Q*(s,a) is differentiable with respect to the action. In this case, the following approximation can be made:

$${max}_{a} {Q}^{*} ( s , a ) \approx {Q}^{*} ( s , π ( s ) )$$

this holds for neural network architectures such as those described herein, as the parameters of the neural network architecture are differentiable.

In certain cases, an off-policy training method may be used. This may help overcome the problem of continuous action spaces. In off-policy training, the intersection control agent learns from historical data obtained from the traffic environment. For example, historical data may be collected in a reply buffer and this is used to train the policy. In off-policy training the training data may be generated independently of a particular policy that is being trained. Off-policy training may be distinguished from on-policy training. In on-policy training the data that is used for training is generated using the policy that is being trained. In the present cases, the neural network architecture that forms part of the intersection control agent may be trained using, amongst others, the following off-policy methods: the Twin Delayed Deep Deterministic policy gradient (TD3) method, as described in the paper “Addressing Function Approximation Error in Actor-Critic Methods” by Fujimoto et al (arXiv 2018—incorporated by reference herein), using Deep Q Networks (DQN), using Double Deep Q Networks (DDQN), and using Deep Deterministic Policy Gradient (DDPG) methods.

### Example Training Configuration

FIG. 8 shows an example training configuration 800 for training the neural network architecture of previous examples. The example training configuration 800 is based on the TD3 method discussed above, although other training methods, such as other off-policy training methods may be alternatively used. The TD3 method allows training with continuous action spaces. FIG. 8 shows an overview of the forward pass and back propagation stages, which are respectively shown using solid and dot-dash lines. The forward pass stage consists of obtaining output layer data after a traffic observation tensor is given as an input to the neural network architecture, during which the data cascades through the network layers. The forward pass stage involves the neural network architecture operating in an inference mode. Back propagation, on the other hand, refers to the process of neural network parameter update via optimisation, such as via the Adam optimizer discussed above.

The example training configuration 800 comprises a traffic simulator 810, an input pre-processor 820, an actor neural network architecture 830, an actor target neural network architecture 832, a set of critic neural network architectures 840, a set of critic target neural network architectures 842, a replay buffer 852, a first data summation element 852, an actor loss controller 862, a critic loss controller 864, and a second data summation element 872. The traffic simulator 810 in the present example is configured with n separate environments. These may comprise different traffic scenarios, different locations, different sets of traffic patterns etc. The use of multiple different simulation environments allows the neural network architectures to learn policies that generalise well to different traffic conditions. The traffic simulator 810 may comprise the PTV Vissim simulator as referenced above.

A method of training using the example training configuration 800 of FIG. 8 may be broken down into five steps: 1) a data initialisation step; 2) a neural network initialisation step; 3) an action step; 4) a return maximisation step; and 5) a target network update step.

During the data initialisation step, the replay buffer 850 is first initialised. The example training configuration 800 implements an off-policy method, and so uses a replay buffer 850 to store past state transitions when the policy is applied to data originating from the traffic simulator 810. Each state transition can be represented as a tuple in the form of (s, s′, a, r) where, s and s′ are the current and next observations, a is the selected action and r is the reward value. Each tuple may then be considered a data sample that is stored in the reply buffer 850. During the third training step described below, at least the actor neural network architecture 830 may be used to determine actions (e.g., in a forward pass) based on current states, s, obtained from the traffic simulator 810. These actions, which may be considered “noisy” actions as the neural network prediction is imperfect, are passed to the traffic simulator 810 and are used to determine next states, s′, where the pairs of current and next state, s and s′, may be used to compute reward values based on vehicle delay times as set out above. The complete generated state transition tuples may then be stored as training samples in the replay buffer 850. During training, the transition tuples in the replay buffer 850 are queried to replay the agent's experience. The transition tuples may be queried either in a shuffled way or in the original order they are stored.

During the neural network initialisation step, the neural network architectures of the training configuration are initialised. The neural network architectures may be constructed using known machine learning libraries such as TensorFlow or PyTorch. In a test implementation of the training configuration 800, six neural networks architectures were provided, one each for the actor and actor target neural network architectures 830, 832 and two each for the critic and critic target neural network architectures 840, 842. Different numbers of neural network architectures may be provided in other implementations. In a preferred case, each neural network architecture has the same number of layers and neurons. The actor neural network architectures 830, 832 learn the policy π(a|s) while the critic neural network architectures 840, 842 learn Q^{π}(s,a) as discussed above. In a preferred case, the actor and critic neural networks may be same, although this need not be the case for all implementations. The main and target neural network architectures do need to be based on the same neural network architecture.

The target neural network architectures provide a preferred optional variation to be more conservative when updating neural network parameters. During training, the target network parameters Ø_{target} are constrained to change at a slower rate than the main network parameters Ø. For example, the target network parameters Ø_{target} may be computed from the main network parameters Ø via aggregation. In one case, polyak averaging may be used such that:

$${∅}_{target} = {ρ∅}_{target} + ( 1 - ρ ) ∅$$

where ρ is an update factor in the range [0,1] and determines the rate of change in the target network parameter set.

During the action step, the intersection control agent as implemented in the form of the actor neural network architecture 830 starts taking actions according to an initial policy. This implements a forward pass. As described above, this may comprise supplying the actor neural network architecture 830 with a current state s and selecting an action a according to the initial policy π(a|s). A forward pass is repeated until the replay buffer 850 is full. In one case, as shown full state transition tuples may be generated by the traffic simulator and these may be complemented with state transition tuple generated as part of the forward pass; in FIG. 8 these are combined via the first data summation element 852. After the replay buffer 850 is full, batches of state transitions may be sampled from the replay buffer 850 for use in training. In FIG. 8, a batch size number of transitions are sampled from the replay buffer 850. For each transition in the sampled batch, the actor target neural network architecture 832 produces a next action a′ as shown in FIG. 8, and the (s′, a′) pair is given as an input to two critic target neural network architectures 842. The critic target neural network architectures 842 return the values of the state-action pair, Qₜₐᵣ₁(s′, a′) and Qₜₐᵣ₂(s′, a′), independent from each other. The final Q-value from the critic target neural network architectures 842 may then be obtained as:

$${Q}_{tar} = r + γ ( min ( {Q}_{tar 1} , {Q}_{tar 2} ) )$$

where γ is a discount factor in the range [0, 1]. Taking the minimum of two Q-values is found to stabilize the optimisation process as optimistic Q-value estimates are avoided by ignoring the higher Qₜₐᵣ value. Following this, the two critic neural network architectures 840 take a (s,a) pair as an input and produce Q₁(s,a) and Q₂(s,a). These Q values, one from each critic neural network architectures 840 may then be used together with Qₜₐᵣ to compute a final critic loss:

$${Loss}_{critic} = MSE ( {Q}_{1} ( s , a ) , {Q}_{tar} ) + MSE ( {Q}_{2} ( s , a ) , {Q}_{tar} )$$

where MSE refers to mean-squared error loss. This loss value is then used by the critic loss controller 864 during backpropagation to update the parameters of the critic neural network architectures 840. This training step where a critic loss is reduced is known as Q-learning. Q-learning step aims to find the optimal parameter set for the critic neural network architectures 840. The next step moves on to policy learning step.

During a return maximisation step, parameter values for the actor neural network architecture 830 are then determined. This may also be referred to as a policy learning step, as it is where the policy π(a|s) is learnt. In this step, an attempt is made to find an optimal parameter set for the actor neural network architecture 830 in order to maximise the expected return (e.g., see the section on the reinforcement learning policy set out above). Based on the Q-value approximation discussed above, the Q-value from the critic neural network architectures 840 is correlated with the expected return, meaning as the Q-value is increased, the expected return approaches optimality. In this case, the loss for the policy learning may be computed as the mean value of the Q-values from the Critics:

$${Loss}_{actor} = - \frac{{Q}_{1} ( s , a ) + {Q}_{2} ( s , a )}{2}$$

This loss function may then be minimised by the actor loss controller 862 to train the parameter values for the actor neural network architecture. During backpropagation, gradient ascent may be used (hence the negative sign in the term above) by differentiating the actor loss with respect to the actor neural network parameters in the direction that maximises the expected return.

In the training configuration 800 of FIG. 8, policy learning may be performed every other iteration whereas Q-learning in the third step may be performed every iteration. This is because, if the Q-learning is poor, the policy becomes poor as well, and it can cause divergence of the loss moving towards minima. However, if Q-learning is performed at double the rate of policy learning then there is better convergence to the optimal parameter set.

During the final target network update step, an update is performed upon the target network parameters of the actor and the critic target neural network architectures 832, 842 (which has not been performed up until this point). The target network parameters may be updated based on the target parameter update equation set out above. In certain examples, the target network parameters may be updated with a so-called “soft” update, where the weights of the actor and critic neural network architectures 830, 840 are aggregated with the existing weights of the actor and the critic target neural network architectures 832, 842, e.g. via polyak averaging into the target networks. Similar to the policy learning, the target network updates may be performed every other step to improve training performance stability.

At least the third to fifth steps above may be repeated until a set of training stop conditions are met. In one case, the training procedure may be repeated regardless of the size of the replay buffer 850. If the replay buffer 850 becomes full, it may be overwritten with new transitions, e.g. starting from the oldest entry as the intersection control agent continues to operate in the simulated traffic environments provided by the traffic simulator 810.

### Example Test Environment

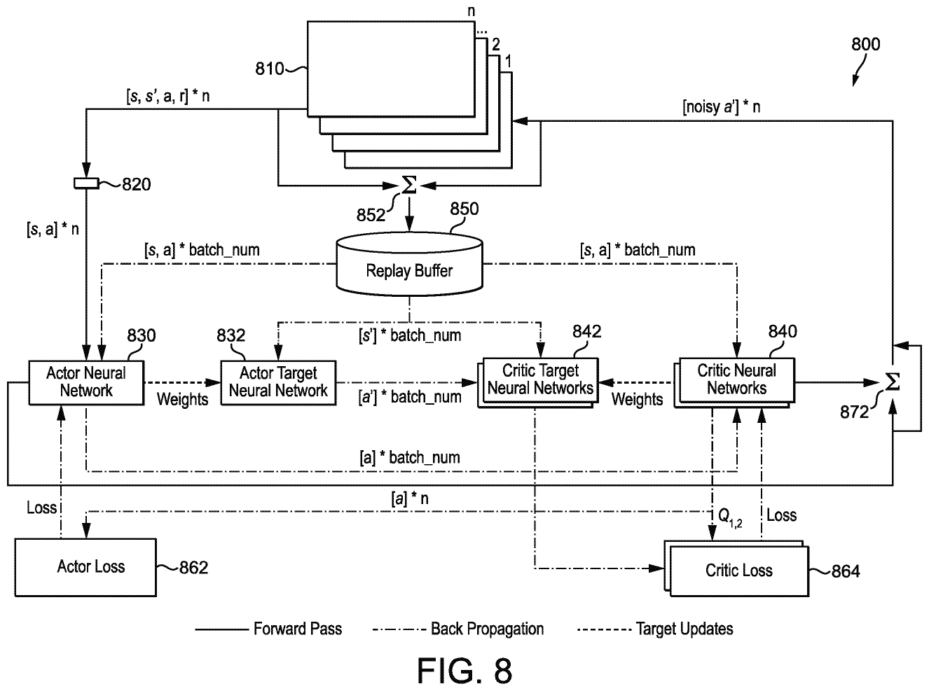

FIG. 9 shows an optional example test environment 900 for an implementation of an intersection control agent 910, such as 140 in FIG. 1. The example test environment 900 comprises the intersection control agent 910, a test platform 920, a shared memory 940, a traffic simulation tool 950 and a driver model executable library 960. The test platform 920 comprises test automation functions 922, data analysis functions 924, an agent interface 926, data logging functions 928, data visualisation functions 930 and a shared memory interface 932. The shared memory 940 is shared between the test platform 920 and the driver model executable library 960. The driver model executable library 960 may comprise a Dynamic Link Library (DLL) implemented in a programming language such as C++. The driver model executable library 960 may comprise a programmed model for testing that implements a simulation of V2I connectivity and driving behaviour control that is accessible from the traffic simulation tool 950 via an application programming interface (API) 962. In test training runs, the driver model executable library 960 was called every 100 ms for each vehicle in the network.

The configuration of FIG. 9 allows for the training and configuration of intersection control agents 910. As indicated in FIG. 9, the example test environment 900 may support multiple intersection control agents 910 running in parallel during training. For example, the multiple intersection control agents 910 may collect data from the traffic simulation tool 950 independent from each other. In one case, an intersection control agent 910 may be implemented using computer program code that is executed by at least one processor. For example, the intersection control agent 910 may be programmed in a programming language such as Python, Java, or C++ and may incorporate classes and functions from machine learning programming libraries (including those mentioned above). The example test environment 900 may be used to train a set of intersection control agents 910 which may then be deployed to road-side units (RSUs) for traffic control. RSUs may comprise embedded computer systems adapted to execute the computer program code of the intersection control agents 140. In certain cases, intersection control agents 910 may comprise a standard configuration, such as a defined set of classes and/or electronic processing hardware, that are then parameterised by a set of parameter values (e.g., weights and biases) as updated during training similar to that described above. Intersection control agents 910 may also be implemented in bespoke hardware units, such as those based on Field Programmable Gate Arrays (FPGAs) and/or Application Specific Integrated Circuits (ASICs). The test platform 920 may be used to provide test automation, data analysis, visualisation and logging features. The test platform 920 may be used as a central hub for experimentation and monitoring during training.

### Example Test Results

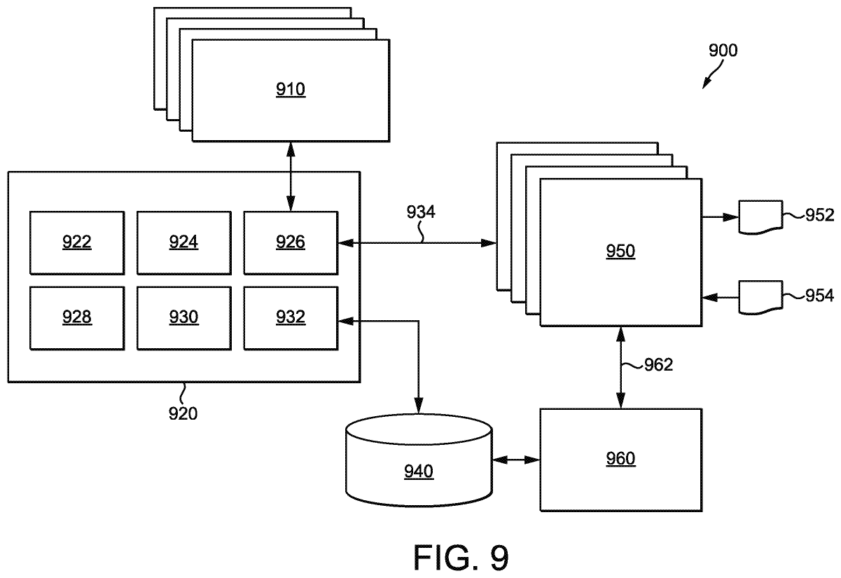

FIG. 10 show a set of initial example results 1000 for a test implementation of an intersection control agent. FIG. 10 shows six charts that are split into two sets of three. The charts show an average vehicle delay (in seconds on the y-axis) with different fleet compositions (the x-axis). The upper set of three charts show a major/major demand ratio, while the lower set of three charts show a major/minor demand ratio. The terms “major” and “minor” refer to the traffic demand properties of lanes intersecting at an intersection. For example, “major/major” refers to a modelled intersection with two busy roads intersecting whereas “major/minor” refers to a modelled intersection with one busy road intersecting a smaller side road. More precisely the demand ratio may be modelled as a ratio of the number of vehicles arriving per hour on different approaching lanes of the intersection. In the present test models, two traffic demand scenarios were tested that represented situations where two links intersect with same or different traffic demand levels. For example, the major/major demand ratio had a ratio of 1, whereas the major/minor demand ratio was 2 (e.g., representing a ratio of North-South and West-East link traffic levels based on vehicles per hour).

The x-axis of the charts shows different penetration levels. For example, the CHV levels refer to different percentages of Connected Human-driven Vehicles within the traffic flow. The data points relating to Connected Autonomous Vehicles (CAVs) model four different CAV behaviours (where B1 represents the most cautious behaviour and B4 represents the most assertive behaviour). In the tests with a mixed fleet of human-driven and autonomous vehicles, the CAVs in the mixture were considered to have the most assertive behaviour (B4). Each chart in the sets of three show data based on a different level of traffic demand: high, medium and low. The charts have test data indicating three different traffic control methods: an artificial intelligence or “AI” traffic control method that uses an intersection control agent as described herein; a traffic light control “TLC” method that uses traffic lights programmed according to standard timings in the art; and a First-Come-First-Served (FCFS) traffic control method where, as the name suggests, priority is given based on who comes first to the intersection. As can be seen the AI traffic control method results in low average vehicle delays across different traffic demand levels and demand ratios, and also across different fleet compositions (i.e. across different mixtures of CHVs and CAVs) and different CAV behaviours. This may be compared to the TLC and FCFS methods which are poor at providing consistently low vehicle delays across different circumstances. For example, although the TLC method resulted in low vehicle delays during periods of high traffic demand, it performed comparatively poorly during periods of medium and low demand (in effect, TLC results in constant delays independent of traffic demand). FCFS methods provide low vehicle delays during times of medium and low demand but perform extremely poorly during periods of high demand. Moreover, the additional delays experienced when using FCFS methods depend on the composition of the traffic, e.g. the methods are susceptible to changes in the autonomy level of the fleet.

In general, the charts of FIG. 10 indicate that higher connected autonomous vehicle penetration rates bring various benefits as long as more advanced traffic control methods are used. Implementing advanced traffic control methods such as those described herein will aid the penetration of connected autonomous vehicles into the traffic flow, which in turn will bring a variety of benefits including reduced vehicle delays, reduced congestion, reduced fuel consumption and reduced gas emissions. These benefits were found to increase as the connected autonomous vehicle penetration ratio increased. The charts of FIG. 10 also indicate that the benefits of connected and autonomous vehicles on public roads are highly dependent on the traffic control method used. When an existing TLC method was used, no significant benefits (<10% under all scenarios) were seen in terms of vehicle delays whereas the AI method offered 7.61% reduced vehicle delays even when there was only 10% autonomous vehicle penetration rate. It can thus be suggested that unless more advanced traffic control methods are used, such as the proposed methods described herein, few significant benefits can be gained with increased autonomous vehicle penetration rates. The present examples provide low delays and improved traffic control across the range of different fleet compositions.

Tests of implementations of the presently described examples show that an intersection control agent is able to adapt to changes in traffic flow and perform well. This is difficult as a traffic control domain is stochastic in nature. The intersection control agent described herein is able to adapt to unseen states and conditions during training. It is therefore likely that once a neural-network-based intersection control agent is trained under a simulation environment, it can be deployed to multiple locations without requiring a special training procedure for every single intersection. Although examples were provided herein in terms of 4-way junction and 4-way roundabout geometries, the intersection control agent may be trained and configured for any suitable intersection geometry as long as the training scenarios are setup appropriately for this objective.

Those skilled in the art will understand that hyperparameters for the neural network architecture described herein may be set based on routine experimentation and/or vary with exact implementation and data set. However, as an example, a test set of test hyperparameters will be set out here for reference. The fully-connected neural network layers (e.g., 522 and 528) may comprise two layers with a ReLU activation function. The hidden fully-connected neural network layer 522 may have a size (i.e., a vector or channel size) of 128. The output fully-connected neural network layer 528 may have a first layer of size 64 and a second layer of size 32. The LSTM cell 526 may have a tanh activation function. The discount factor γ may be set as 0.998. The polyak averaging factor ρ may be 0.05. The learning rate for the actor neural network architecture may be set as 1e⁻⁴ and the learning rate for the critic neural network architecture may be set as 1e⁻³. Noise with an initial scale of 0.15 and decay steps of 15×10³ may be added to the target actions (a′) during training as shown in FIG. 8. An exploration noise initial scale may be set as 0.2 with decay steps of 15×10³. A batch size may be set as 256 with a replay buffer size of 50×10³. For an Adam optimizer ϵ was 10⁻⁸.

### Other Example Implementations

Although examples of an intersection control agent have been described above, certain implementations may also provide an adapted control system for a connected vehicle. For example, the control system may be adapted to perform vehicle functions similar to those shown in FIG. 2. In one case, a control system for a connected vehicle comprises a kinematics engine to determine kinematics data associated with an approach to an intersection, a communications interface to communicate with an intersection control agent, and a vehicle control engine to control movement of the connected vehicle from an arrival lane of the intersection to a desired exit lane of the intersection. In this case, the control system may be configured to: communicate the kinematics data to the intersection control agent; receive timing data from intersection control agent indicating an allotted time window to cross from the arrival lane to the desired exit lane; and control movement of the connected vehicle in accordance with the received timing data. The timing data is determined by the intersection control agent as described herein, e.g. using a neural network architecture and a trajectory conflict engine, where the neural network architecture maps an observation tensor for lanes of the intersection to a priority tensor for the lanes of the intersection, the observation tensor comprising data derived from the communicated kinematics data, the trajectory conflict engine using the priority tensor to determine the timing data based on occupation of crossing points of the intersection that avoid collisions between connected vehicles present at the intersection.

In certain implementations, the intersection control agent may be provided as part of an infrastructure kit or intersection system. For example, an intersection may comprise a plurality of approach and exit lanes, a critical area comprising crossing points between the approach and exit lanes, and one or more intersection control agents, where each intersection control agent is configured as described herein. In one case, each intersection control agent comprises a neural network architecture to determine priorities for a set of connected vehicles present at the intersection and a trajectory conflict engine to receive the priorities for the set of connected vehicles present at the intersection and to determine timing data for occupation of the crossing points of the intersection that avoid collisions between the set of connected vehicles. The intersection may have a control area representing a control range for the one or more intersection control agent, e.g. the control area may comprise at least a wireless communications range for the one or more intersection control agents, wherein the one or more intersection control agents are configured to wirelessly communicate with connected vehicles within the control area to control traffic flow within the critical area. The wireless communication in this case (and in other examples described herein) includes both direct wireless communication, e.g. between the intersection control agents and the connected vehicles, and indirect wireless communications, e.g. using a remote server based (e.g., a so-called “cloud”) interface, where both the intersection control agents and the connected vehicles communicate with one or more remote servers to exchange the data described herein.

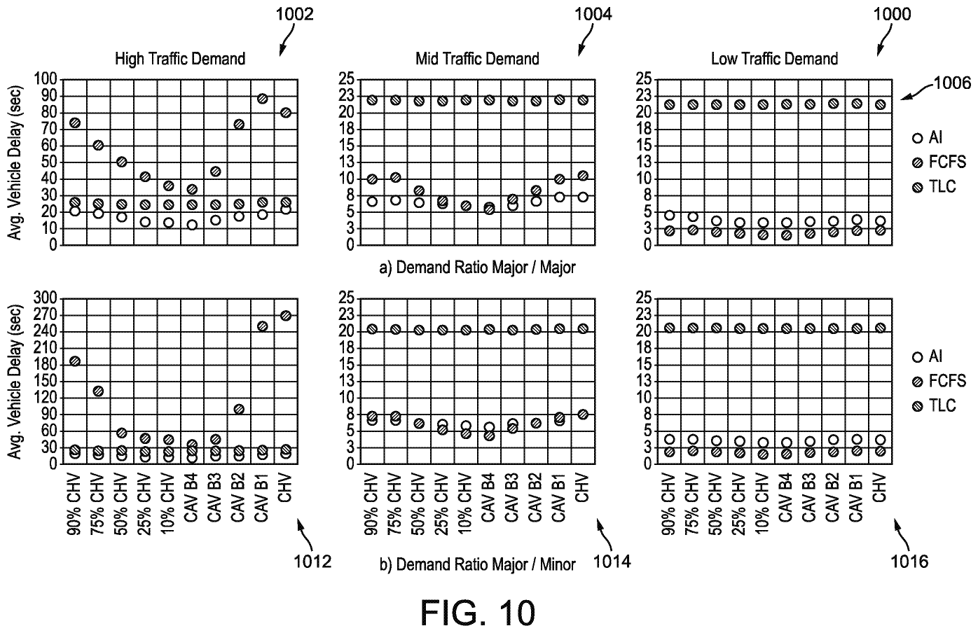

FIG. 11 shows an example method 1100 of controlling traffic flow at an intersection. The method may implement operations described above. In FIG. 11, there is a first operation 1102 of obtaining at least kinematics data from a set of connected vehicles approaching the intersection. At operation 1104, the method 1100 comprises generating an observation tensor (e.g., a data vector) for the lanes of the intersection from the kinematics data. This may be performed as explained in the Traffic State Representation section above. At operation 1106, the observation tensor for lanes of the intersection is mapped to a priority tensor (e.g., output action space vector) for the lanes of the intersection using a trained neural network architecture. The neural network architecture may be configured as described with reference to FIGS. 5A and 5B and may be trained as described with reference to FIG. 8. At operation 1108, the method 1100 comprises determining timing data for occupation of crossing points of the intersection based on the priority tensor. The timing data may be determined to avoid collisions between the set of connected vehicles. The timing data may be computed as described in the Example Trajectory Conflict Procedure section. Finally, at operation 1110 the movement of the set of connected vehicles across the intersection is instructed based on the timing data. This may comprise transmitted schedule data 250 as described with reference to FIG. 2.

As described above, in certain cases the neural network architecture implements a reinforcement learning policy, the priority tensor being used to select an action from an action space for the intersection and the observation tensor representing a state of the intersection, a reward function being defined based on vehicle delay times at the intersection, the parameter values of the neural network architecture being trained based on an optimisation of the reward function. For example, the priority tensor may represent a crossing order of vehicles at the intersection in which selecting a vehicle as an action is an available element in the action space. The kinematics data may indicate at least a current lane of the intersection and a desired exit lane of the intersection for one or more lead connected vehicle in one or more respective in-use lanes of the intersection and comprise distance and timing data that is useable to derive an estimate of a crossing time for each lead connected vehicle, the crossing time being an estimate of the time to move across a desired crossing point. The observation tensor may comprise a set of observation vectors for at least a set of in-use lanes of the intersection. An observation vector for a given lane may comprise data useable to derive one or more of crossing parameters for a lead connected vehicle in the given lane and aggregate kinematics for connected vehicles in the given lane.

In certain cases, the mapping of operation 1106 may comprise, for each of a plurality of timesteps: pre-processing the observation tensor using a first set of one or more neural network layers; extracting, using a second set of one or more neural network layers, spatio-temporal features from the pre-processed observation tensor; and mapping the spatio-temporal features to the priority tensor using a third set of one or more neural network layers. In particular, in certain cases, the mapping may comprise, for a given timestep: normalising data within the observation tensor; passing the observation tensor to an input layer of the neural network architecture; passing data derived from an output of the input layer to a hidden set of one or more fully-connected neural network layers; passing data derived from an output of the hidden set of one or more fully-connected neural network layers to one or more recurrent neural network layers, the one or more recurrent neural network layers also receiving an output generated by the one or more recurrent neural network layers on a previous timestep; passing data derived from an output of the one or more recurrent neural network layers to an output set of one or more fully-connected neural network layers; and obtaining the priority tensor as an output of an output layer of the neural network architecture, the output layer receiving data derived from the output set of one or more fully-connected neural network layers.

In one case, determining timing data for occupation of crossing points of the intersection based on the priority tensor comprises: obtaining trajectory data indicating arrival lane-exit lane pairs for a set of lead connected vehicles at the intersection; generating an ordered list of crossing points based on the priorities for the set of connected vehicles present at the intersection received from the neural network architecture and the trajectory data; and determining crossing point occupancy for a set of timing windows using the ordered list of crossing points such that at most only one vehicle is present in each crossing point for each of the set of timing windows. More details are described with reference to FIG. 7.

In one case, there may be a corresponding method of controlling a connected vehicle at an intersection. This method may comprise generating kinematics data associated with an approach to the intersection, the kinematics data indicating an arrival lane of the intersection for the connected vehicle and a desired exit lane of the intersection for the connected vehicle, transmitting the kinematics data to an intersection control agent located within a control area of the intersection, receiving timing data from the intersection control agent indicating an allotted time window to cross from the arrival lane to the desired exit lane, the timing data being generated by the intersection control agent based on a neural network architecture configured to map an observation tensor generated based on the kinematics data to priorities for a set of connected vehicles present at the intersection, a priority for the connected vehicle in the priorities being used to determine timing data such that the connected vehicle does not occupy a crossing point between the arrival lane and the desired exit lane together with one or more other connected vehicle within the allotted time window, and controlling movement of the connected vehicle in accordance with the received timing data.

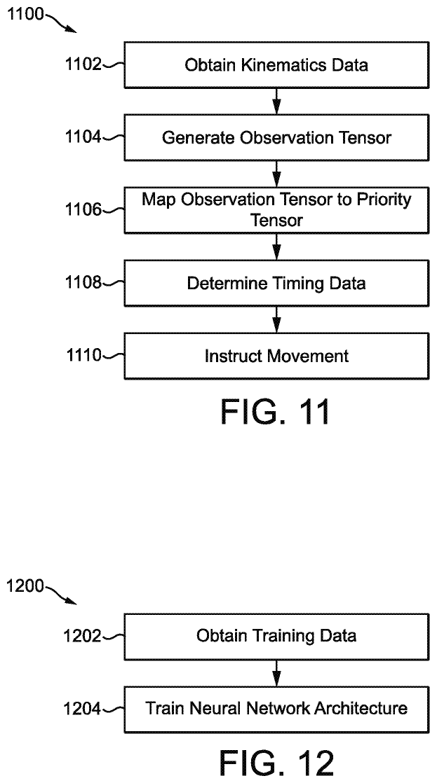

FIG. 12 shows a method 1200 of training a neural network architecture for a traffic control system. This method 1200 may provide training as shown in FIG. 8. The traffic control system controls traffic flow at an intersection. In particular, the method 1200 comprises obtaining training data comprising state transitions for the intersection, a state transition in the state transitions comprising data representing two successive states of the intersection, and training a neural network architecture to predict the set of priorities based on data representing a state of the intersection, said training comprising using the training data to determine parameter values for the neural network architecture that optimise an objective function, the objective function being a function of an expected cumulative future reward, e.g. an expected cumulative future discounted reward, computed from the state transition, wherein the determined parameter values for the neural network architecture are useable to predict the set of priorities based on an observed state of the intersection, the set of priorities being used by the traffic control system to control occupation of crossing points of the intersection that avoid collisions between connected vehicles present at the intersection. In this case, “discounted” refers to the “gamma” (γ) factor, which is a way to adjust the importance of how much rewards at future time steps are valued, e.g. starting from t+1.

In certain cases, training the neural network architecture comprises: using an actor-critic configuration comprising at least one actor version of the neural network architecture and at least one critic neural network architecture, wherein the at least one actor version of the neural network architecture is configured to learn a policy that maps a set of priorities as an action to a state of the intersection, wherein the at least one critic neural network architecture is configured to map state-action pairs to Q values, and wherein the objective function for the at least one actor version of the neural network architecture is a function of the Q values output by the at least one critic neural network architecture. An example actor-critic configuration is described with reference to FIG. 8.

The method 1200 may further comprise using one or more target neural network architectures to control the update of the parameter values. The state transitions for the intersection may be derived from one or more of measured traffic data and a traffic simulation system. In certain cases, the neural network architecture implements a policy and off-policy training is performed. In these cases, the method may further comprise using a replay buffer to store data generated during iterations of the training together with the state transitions.

Comparison with Other Traffic Control Systems

The presently described invention provides technical benefits as compared to other traffic control systems. For example, certain comparative traffic control systems may implement control that is effectively the FCFS method that has the problems discussed above. Other comparative traffic control systems may propose methods of establishing communication between a RSU and vehicles at intersection but do not describe advanced control methods to be performed at the RSU. The present examples also differ from image-detection-based collision avoidance system for existing traffic light control systems or peer-to-peer vehicle control methods. Comparative traffic control systems do not provide an interaction control agent that controls a traffic flow using a neural network architecture as described herein.

The present examples have numerous benefits. Once an interaction control agent has been trained, it can be deployed to multiple intersections without requiring any further training or location specific procedures. This makes the method very powerful and reduces the cost of installations. For example, the training of the neural network architecture allows it to learn parameters that adapt to conditions as represented in the observation tensor by changing the priority tensor that is output. In certain examples, the described interaction control agent may be pro-active, as it knows what happened in the past (e.g., via the spatio-temporal feature extraction presented herein) and it can estimate how traffic will evolve in the future. So, control decisions are made with that in mind to reduce vehicle delays. Certain examples also simply require wireless communication between vehicles and the RSU, in these examples there is no need for other sensors on the road. This greatly reduces the cost of installation. The proposed control methods may alo be implemented for human driven vehicles as well as connected autonomous vehicles, e.g. using a dashboard inside the vehicle to display the intersection crossing information received from the intersection control agent to the human drivers. Certain examples described herein do not require an explicit traffic control method, which is a powerful benefit. In the present examples, the intersection control agent can learn by trial-and-error. In contrast, many existing traffic light systems require a complex model of traffic. The use of simulation tools, e.g. for training as described above, also further accelerates the deployment time.

If not explicitly stated, all of the publications referenced in this document are herein incorporated by reference. The above examples and embodiments are to be understood as illustrative. Further examples and embodiments are envisaged. Although certain components of each example and embodiment have been separately described, it is to be understood that functionality described with reference to one example or and embodiment may be suitably implemented in another example or and embodiment, and that certain components may be omitted depending on the implementation. It is to be understood that any feature described in relation to any one example or and embodiment may be used alone, or in combination with other features described, and may also be used in combination with one or more features of any other of the examples or and embodiments, or any combination of any other of the examples or and embodiments. For example, features described with respect to the system components may alo be adapted to be performed as part of the described methods. Furthermore, equivalents and modifications not described above may also be employed without departing from the scope of the invention, which is defined in the accompanying claims.

1-25. (canceled)

26. Apparatus for traffic control at an intersection, the apparatus comprising:
a neural network architecture to determine priorities for a set of connected vehicles present at the intersection, the neural network architecture mapping an observation tensor for lanes of the intersection to a priority tensor for the lanes of the intersection, the observation tensor comprising kinematics data for vehicles in the lanes of the intersection; and
a trajectory conflict engine to receive the priorities for the set of connected vehicles present at the intersection and to determine timing data for occupation of crossing points of the intersection that avoid collisions between the set of connected vehicles,
wherein the apparatus uses the timing data to instruct movement of the set of connected vehicles across the intersection.

27. The apparatus of claim 26, wherein the neural network architecture implements a reinforcement learning policy, the priority tensor representing a crossing order of vehicles at the intersection in which selecting a vehicle as an action is an available element in the action space and the observation tensor representing a state of the intersection, a reward function being defined based on vehicle delay times at the intersection, the parameter values of the neural network architecture being trained based on an optimization of the reward function.

28. The apparatus of claim 26, wherein the neural network architecture comprises:
one or more hidden fully-connected neural network layers to process data derived from the observation tensor;
one or more recurrent neural network layers to process data derived from the one or more hidden fully-connected neural network layers; and
one or more output fully-connected neural network layers to process data derived from the one or more recurrent neural network layers and to output data for use in deriving the priority tensor.

29. The apparatus of claim 26, comprising:
a connected vehicle interface to receive communications from one or more connected vehicles as said vehicles approach the intersection,
wherein the connected vehicle interface receives at least distance and timing data from each connected vehicle,
wherein the kinematics data for vehicles in the lanes of the intersection comprises kinematics data for lead connected vehicles in a set of in-use lanes and aggregate kinematics data for the lanes of the intersection,
wherein the kinematics data for vehicles in the lanes of the intersection is computed based on the distance and timing data received via the connected vehicle interface.

30. The apparatus of claim 29, wherein the distance and timing data is useable to derive an estimated arrival time of the connected vehicle to an entry point of the intersection and a distance of the connected vehicle to an entry point of the intersection.

31. The apparatus of claim 29, wherein the distance and timing data indicates a current lane of the intersection for the connected vehicle and a desired exit lane of the intersection for the connected vehicle, wherein the distance and timing data is useable to derive an estimate of a crossing time for the connected vehicle, the crossing time being an estimate of the time to move across a desired set of one or more crossing points.

32. The apparatus of claim 26, wherein the observation tensor comprises a set of observation vectors for at least a set of in-use lanes of the intersection, an observation vector for a given lane comprising data useable to derive one or more of crossing parameters for a lead connected vehicle in the given lane and aggregate kinematics for connected vehicles in the given lane.

33. The apparatus of claim 32, wherein an observation vector for a given lane comprises data useable to derive one or more of:
an autonomy level of a lead connected vehicle for the given lane;
a distance of the lead connected vehicle to the intersection with respect to the given lane;
an estimated arrival time of the lead connected vehicle to the intersection with respect to the given lane;
an identifier for the given lane;
an identifier for a desired exit lane of the intersection for the lead connected vehicle;
an aggregate vehicle speed for the given lane;
an aggregate vehicle delay for the given lane; and
a measure of the aggregate vehicle delay for the given lane as compared to an aggregate vehicle delay for the set of in-use lanes of the intersection.

34. The apparatus of claim 26 wherein data forming the observation tensor is normalized prior to being provided as input to the neural network architecture.

35. The apparatus of claim 26,
wherein the trajectory conflict engine obtains trajectory data indicating arrival lane-exit lane pairs and generates an ordered list of crossing points based on the priorities for the set of connected vehicles present at the intersection received from the neural network architecture and the trajectory data,
wherein the trajectory conflict engine is further configured to determine crossing point occupancy for a set of timing windows using the ordered list of crossing points such that at most only one vehicle is present in each crossing point for each of the set of timing windows.

36. A control system for a connected vehicle comprising:
a kinematics engine to determine kinematics data associated with an approach to an intersection;
a communications interface to communicate with an intersection control agent; and
a vehicle control engine to control movement of the connected vehicle from an arrival lane of the intersection to a desired exit lane of the intersection,
wherein the control system is configured to:
communicate the kinematics data to the intersection control agent;
receive timing data from intersection control agent indicating an allotted time window to cross from the arrival lane to the desired exit lane; and
control movement of the connected vehicle in accordance with the received timing data,
wherein the timing data is determined by the intersection control agent using a neural network architecture and a trajectory conflict engine, the neural network architecture mapping an observation tensor for lanes of the intersection to a priority tensor for the lanes of the intersection, the observation tensor comprising data derived from the communicated kinematics data, the trajectory conflict engine using the priority tensor to determine the timing data based on occupation of crossing points of the intersection that avoid collisions between connected vehicles present at the intersection.

37. A method of controlling traffic flow at an intersection, the method comprising:
obtaining at least kinematics data from a set of connected vehicles approaching the intersection;
generating an observation tensor for the lanes of the intersection from the kinematics data;
mapping the observation tensor for lanes of the intersection to a priority tensor for the lanes of the intersection using a trained neural network architecture;
determining timing data for occupation of crossing points of the intersection based on the priority tensor, the timing data being determined to avoid collisions between the set of connected vehicles; and
instructing movement of the set of connected vehicles across the intersection based on the timing data.

38. The method of claim 37, wherein the neural network architecture implements a reinforcement learning policy, the priority tensor being used to select an action determined from an action space for the intersection and the observation tensor representing a state of the intersection, a reward function being defined based on vehicle delay times at the intersection, the parameter values of the neural network architecture being trained based on an optimisation of the reward function.

39. The method of claim 37, wherein the kinematics data indicates at least a current lane of the intersection and a desired exit lane of the intersection for one or more lead connected vehicle in one or more respective in-use lanes of the intersection, and comprises distance and timing data that is useable to derive an estimate of a crossing time for each lead connected vehicle, the crossing time being an estimate of the time to move across a desired crossing point.

40. The method of any claim 37, wherein the observation tensor comprises a set of observation vectors for at least a set of in-use lanes of the intersection, an observation vector for a given lane comprising data useable to derive one or more of crossing parameters for a lead connected vehicle in the given lane and aggregate kinematics for connected vehicles in the given lane.

41. The method of claim 37, wherein the mapping comprises, for each of a plurality of timesteps:
pre-processing the observation tensor using a first set of one or more neural network layers;
extracting, using a second set of one or more neural network layers, spatio-temporal features from the pre-processed observation tensor; and
mapping the spatio-temporal features to the priority tensor using a third set of one or more neural network layers.

42. The method of any claim 37, wherein the mapping comprises, for a given timestep:
normalizing data within the observation tensor;
passing the observation tensor to an input layer of the neural network architecture;
passing data derived from an output of the input layer to a hidden set of one or more fully-connected neural network layers;
passing data derived from an output of the hidden set of one or more fully-connected neural network layers to one or more recurrent neural network layers, the one or more recurrent neural network layers also receiving an output generated by the one or more recurrent neural network layers on a previous timestep;
passing data derived from an output of the one or more recurrent neural network layers to an output set of one or more fully-connected neural network layers; and
obtaining the priority tensor as an output of an output layer of the neural network architecture, the output layer receiving data derived from the output set of one or more fully-connected neural network layers.

43. The method of claim 37 wherein determining timing data for occupation of crossing points of the intersection based on the priority tensor comprises:
obtaining trajectory data indicating arrival lane-exit lane pairs for a set of lead connected vehicles at the intersection;
generating an ordered list of crossing points based on the priorities for the set of connected vehicles present at the intersection received from the neural network architecture and the trajectory data; and
determining crossing point occupancy for a set of timing windows using the ordered list of crossing points such that at most only one vehicle is present in each crossing point for each of the set of timing windows.
